(19) United States
(12) Patent Application Publication
(10) Pub. No.: US 2024/0428521 A1
(43) Pub. Date: Dec. 26, 2024

(54) LOCATION-BASED COMPUTER-ALTERED REALITY DATA RENDERING MANAGEMENT USING RENDERING ORIENTED CHARACTERISTIC DATA

(71) Applicant: T-Mobile USA, Inc., Bellevue, WA (US)

(72) Inventor: Wen-Ping Ying, Bellevue, WA (US)

(21) Appl. No.: 18/339,739

(22) Filed: Jun. 22, 2023

(51) Int. Cl. G06T 19/00

(52) U.S. Cl. CPC G06T 19/00

(57) ABSTRACT

Described herein are techniques, devices, and systems for utilizing network locations to manage rendering of computer-altered reality data based on activity data. For example, the computer-altered reality data, which can include extended reality (XR) data, can be rendered based on rendering location information. The rendering location information can include network category information associated with locations of the networks. The networks can be utilized to render the computer-altered reality data based on characteristics data. The computer-altered reality data being rendered can be aggregated, and transmitted to the user devices, by network locations within threshold distances of the user devises.

### BACKGROUND

Systems and networks are utilized to operate utilizing types of computer-altered reality technologies, including an extended reality (XR) technology. The systems and networks, which are operated utilizing the XR technology, manage XR data, which can include augmented reality (AR) data, virtual reality (VR) data, mixed reality (MR) data, or a combination thereof. The systems and networks being operated utilizing the XR technology enable mobility of the mobile devices to be increased in comparison to other systems and networks being operated utilizing other computer-altered reality technologies, such as an MR technology. The XR technology enables the mobile devices to access, via wide area access, a metaverse established by the XR data by which the mobile devices are communicatively coupled to a three-dimensional (3D) internet. The mobile devices, accessing the metaverse, enable users to interact with a real world, a digital world, a virtual world, or a combination thereof.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts an example network environment for location-based computer-altered reality data rendering management using rendering oriented characteristic data

FIG. 2 depicts an example presentation of computer-altered reality data being managed by location-based computer-altered reality data rendering management using rendering oriented characteristic data.

FIG. 3 depicts an example process for location-based computer-altered reality data rendering management using rendering oriented characteristic data illustrated in FIGS. 1 and 2.

FIG. 4 depicts an example system architecture for a computing device.

### DETAILED DESCRIPTION

Techniques for location based computer-altered reality data rendering management in systems and networks using characteristic data (or “rendering oriented characteristic data”) are discussed herein. For example, the computer-altered reality data, which can include extended reality (XR) data, can be rendered at various locations based on rendering information. The rendering information can include rendering location information associated with network category information, which can be associated with the rendering oriented characteristic data. The rendering location information can be associated with locations of the networks, which can include, for example, fifth generation (5G) networks. The networks can be utilized to render the computer-altered reality data based on the characteristic data (e.g., item characteristic data, object characteristic data, etc.). The computer-altered reality data being rendered utilizing various locations (e.g., network locations) can be aggregated, and transmitted to mobile devices (or “user devices”), for example, by the network locations, which can include network locations within threshold distances from the user devices.

The rendering location information, which can be associated with the network category information, can be associated with different network locations utilized to render the computer-altered reality data. The network locations can be utilized to render different portions (e.g., item oriented portions, object oriented portions, etc.) of the computer-altered reality data, respectively. The network category information can be utilized to indicate network categories, including edges of the networks, near-edges of the networks, mid-edges of the networks, far-edges of the networks, other network categories, or any combination thereof. In some examples, the edges, the near-edges, the mid-edges, the far-edges, and the other network categories can be associated with the network locations within the threshold distances (e.g., physical distances, network distances (e.g., based on latency, etc.), and the like) (e.g., threshold distances in an increasing order) from the user devices. In those or other examples, the edges, the near-edges, the mid-edges, the far-edges, and the other network categories can be associated with different network types, respectively.

Different portions and/or sets of the computer-altered reality data can be rendered at the network locations based on the characteristic data. The characteristic data can include various types of rendering oriented characteristic data (e.g., item characteristic data, object characteristic data, any other types of characteristic data, or any combination thereof), which can be utilized for rendering of the different portions and/or sets (e.g., sets of the computer-altered reality data associated with items, respectively) (e.g., sets of the computer-altered reality data associated with objects, respectively) of the computer-altered reality data. For example, the characteristic data can include data associated with item interactivity (e.g., object interactivity) (e.g., user-object interactivity, object-object interactivity, etc.) associated with items (e.g., various types of objects, such as users, vehicles, buildings, etc.), data associated with physics (e.g., item physics, object physics) associated with the items, data associated with speeds of motions (e.g., motions of items, motions of objects, etc.), data associated with rendering complexity, data associated with near/far views from camera viewpoints (e.g., first person viewpoints), various other types of characteristic data, or any combination thereof.

The characteristic data can also include data (e.g., user device characteristic data) associated with user device characteristics (e.g., characteristics associated with the user devices). For example, the user device characteristic data can include location data (or “user device location data”) (e.g., location identifiers indicating locations of the user devices) and/or capability data (e.g., data associated with resolutions, refreshment rates, frame rates, user controls, etc., or any combination thereof) associated with the user devices. Alternatively or additionally, the characteristic data can include user characteristic data (e.g., user interactivity characteristic data, such as data based on user locations, data based on user capabilities, and so on, or any combination thereof) associated with users. In some examples, the user characteristic data can include data associated with activity (e.g., user activity), user utilization of the user devices, user utilization of the computer-altered reality data, and so on, or any combination thereof. For example, the user interactivity characteristic data can include data based on object manipulability (e.g., object manipulated based on the user interactivity and/or actions, etc.), data based on interactivity (e.g., user and/or item interactivity) and so on, or any combination thereof.

The rendering oriented characteristic data can be utilized to identify priorities associated with different portions of the computer-altered reality data. The portions of the characteristics data can be analyzed to identify different metrics. The metrics can include interaction metrics, motion metrics, other metrics of other types, or any combination thereof. The metrics associated with the portions of the characteristics data can be utilized to identify the network locations utilized to render the computer-altered reality data.

The rendered computer-altered reality data can be collected from the network locations that generate the rendered computer-altered reality data. The rendered computer-altered reality data being collected can be transmitted to the user devices. The network locations including, for example, the edges of the networks, which collect the rendered computer-altered reality data, can include network locations being closer to the user devices than other network locations. The rendered computer-altered reality data being collected can be aggregated and utilized by the user devices. The rendered computer-altered reality data being collected and transmitted can be received and utilized by the user devices to display the rendered computer-altered reality data.

Utilizing the characteristics data associated with the activity (e.g., the item and/or user activity) and/or other activity to manage location based rendering of the computer-altered reality data has many technical benefits. Servers located within close proximities of the user devices conserve compute resources based on rendering of various types of computer-altered reality data being performed by other more distance servers. Portions of the computer-altered reality data being rendered by other more distance servers can include data of lower priorities, such as computer-altered reality data being associated with computer generated items experiencing relatively fewer interactions and/or computer-altered reality data being associated with computer generated items experiencing relatively less motion. In some examples, the portions of the computer-altered reality data being rendered by other more distance servers may include data that requires fewer compute resources (e.g., data with less frequent rendering needs), for rendering, such as data (e.g., data associated with relatively fewer interactions and/or with relatively less extreme types of motions) that requires fewer compute resources for rendering.

Compute and memory resources of some of the servers, which may be more distant (or “remote”) from the user devices, and which may be utilized to process the lower priority data, may be conserved (e.g., the compute and memory resources of the relatively remote servers may be conserved as a result of requirements for uses of those resources being less frequent). The compute and memory resources of the servers, being more remote from the user devices may be conserved based on higher priority data being processed by the servers being relatively closer to the user devices, the higher priority data often being relatively more demanding processing-wise (e.g., the compute and memory resources of the relatively remote servers may be conserved based on the higher priority data being rendered by the relatively closer servers, which may be capable of enabling faster and more frequent uses of resources of the relatively closer servers).

While rendering of the computer-altered reality data according to conventional technologies may result in slower processing and/or rendering of the computer-altered reality data and consequential delays, the compute and memory resources of the servers being relatively closer to the user devices according to the techniques discussed herein may be utilized more efficiently and effectively. By utilizing the compute and memory resources of the servers more efficiently and effectively, the conserved compute and memory resources may be made available to be allocated for other tasks.

Compute and memory resources of the mobile devices according to the techniques discussed herein may be conserved more than in conventional systems. The mobile devices operating according to the techniques discussed herein may exchange computer-altered reality data being rendered by various servers at different locations based on priorities of the data. By exchanging the computer-altered reality data being rendered by the servers at the different locations based on the priorities of the computer-altered reality data, the mobile devices may receive rendered computer-altered reality data at different rates based on the priorities of the computer-altered reality data.

By receiving the rendered computer-altered reality data at the different rates, relatively higher priority rendered computer-altered reality data may be obtained by the mobile devices relatively sooner, and/or relatively more frequently, than lower priority data. In existing networks and systems, rendered data may not be available for utilization by the mobile devices in a timely fashion, based on delays occurring during data rending that is performed by only certain servers located near the mobile devices. In comparison to the existing networks and systems, rendered computer-altered reality data according to the techniques discussed herein may be obtained by the mobile devices at correspondingly appropriate times, with minimal delays.

Due to the rendered computer-altered reality data being obtained by the mobile devices according to the techniques discussed herein at correspondingly appropriate times, the needs of local compute resources may not be required. The computer-altered reality data being obtained by the mobile devices according to the techniques discussed herein may enable the mobile devices to be relatively smaller, to have relatively smaller form factors, to be relatively lighter, to experience relatively less power consumption, to include relatively smaller amounts of processing, memory, and power resources, and so on, or any combination thereof. The mobile devices according to the techniques discussed herein, which may, for example, be relatively smaller and may include relatively smaller amounts of processing and memory resources, may still effectively display high quality rendered computer-altered reality data based on the rendered computer-altered reality data being at correspondingly appropriate times.

Furthermore, management of network resources of the networks utilized to exchange communications associated with rendering of the computer-altered reality data may be improved according to the techniques discussed herein. While improvements to compute resources may impact user experiences relatively more than network resources, improvements to network resources according to the techniques discussed herein also significantly contribute to optimization of the user experience. Because 5G networks have large amounts of capacity and large amounts of bandwidth, propagation properties are often stronger for transceivers that are spaced relatively close together. By utilizing servers that are relatively close to the mobile devices to render larger portions of data that require faster rendering processing, total amounts of data being transmitted at longer distances can be decreased, and delays for rendering data that requires faster rendering processing can be decreased.

Higher priority data, such as computer-altered reality data being associated with computer-altered reality items experiencing relatively greater and/or more frequent interactions and/or computer-altered reality data being associated with computer generated items experiencing relatively greater and/or more frequent motion, may be transmitted utilizing fewer network resources than in existing systems. By rendering the higher priority computer-altered reality data at servers located relatively closer to the user devices, fewer network resources are consumed than in conventional systems that do not select network locations for rendering the computer-altered reality data. The networks according to the techniques discussed herein consume relatively fewer resources than in existing systems that transmit, at longer distances, larger amounts of various types of computer-altered reality data, including computer-altered reality items experiencing relatively greater and/or more frequent interactions and/or computer-altered reality data being associated with computer generated items experiencing relatively greater and/or more frequent motion.

Moreover, the tiered rendering (e.g., location based rendering) techniques according to the techniques discussed herein reduce overall amounts of network traffic. The computer-altered reality data, which can include various types of data, such as foreground data requiring faster rendering processing, and background data not requiring as fast of rendering processing, can be rendered at locations capable of rendering according to needs of various types of data. Background objects can be rendered by servers farther from mobile devices, and foreground objects can be rendered by servers closer to mobile devices.

By utilizing the various types of data at locations capable of rendering the computer-altered reality data according to needs of the various types of data, resources such as edge servers can be conserved. The edge servers, which typically can become overloaded at peak times or times at which many mobile devices gathered together in relatively small and/or confined locations (e.g., mobile devices at particular events, in ball-parks, event venues, etc.), can be utilized to render high priority data (e.g., at 60-75 frames/second, etc.), and can send off other data to be rendered by other servers. Because the other data being sent off by the edge servers is being rendered more slowly (e.g., 15 frames/second, 10 frames/second, etc.), overall amounts of air traffic can be decreased.

By utilizing edge servers, for example, to manage location based rendering, overall utilization of compute, memory, and network resources can be improved according to the techniques discussed herein, in comparison to existing systems, that do not utilize location based rendering. The edge servers, which can be utilized to blend all of the rendered data received from other servers according to the techniques discussed herein, can identify how the rendered data is to be collected and/or assembled for transmission to, utilization by, the mobile devices.

The edge servers identifying how the rendered data is to be collected and/or assembled, which can utilize beacons (or “heartbeats”) being sent to the servers performing the rendering, can enable the servers to render portions of the data (e.g., the computer-altered reality data). The edge servers, which can receive the rendered data from the servers and blend together the rendered data, can reduce consumption of resources and reduce delays that might otherwise occur according to conventional technology. Existing systems, without having capabilities to utilize edge servers to distribute data to be rendered, and to blend the rendered data, experience larger delays and network congestion, in comparison utilizing the location based rendering according to the techniques discussed herein.

The systems, devices, and techniques described herein can be implemented in a number of ways, for example, in the context of protocols associated with one or more of third generation (3G), fourth generation (4G), 4G long term evolution (LTE), and/or 5G protocol. In some examples, the network implementations can support standalone architectures, non-standalone architectures, dual connectivity, carrier aggregation, etc. References are made to the accompanying drawings that form a part hereof, and in which are shown by way of illustration specific configurations or examples, in which like numerals represent like elements throughout the several figures. Example implementations are provided below with reference to the following figures.

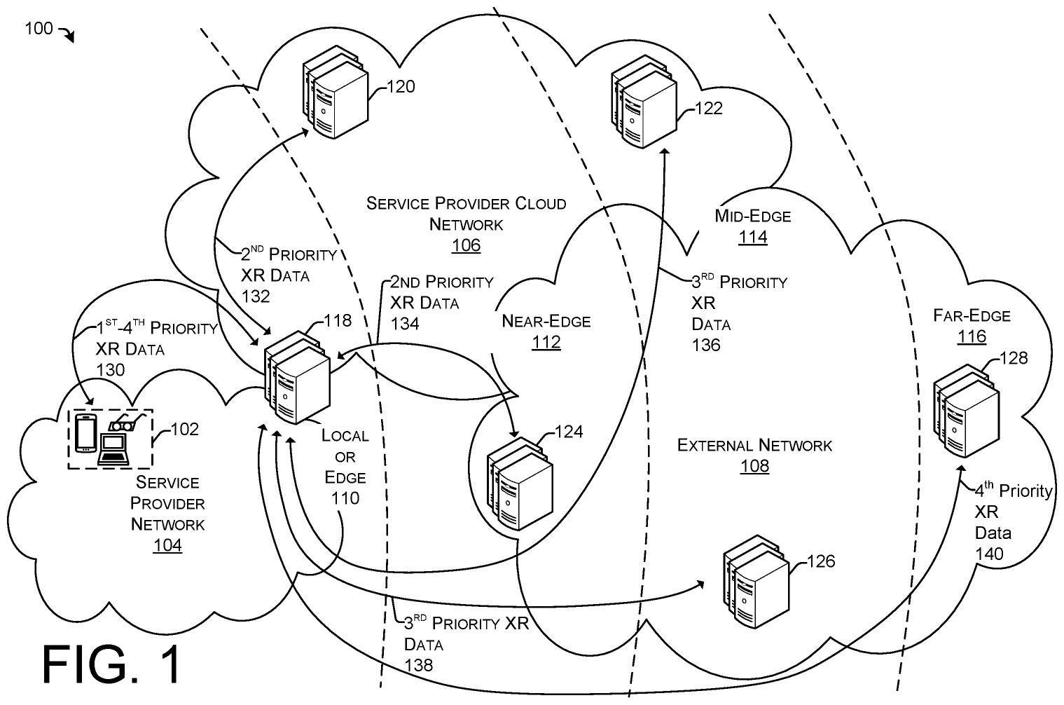

FIG. 1 depicts an example network environment 100 for location-based computer-altered reality data rendering management using rendering oriented characteristic data. In some examples, the network environment 100 can include one or more user equipment (also referred to herein as “user device(s)”) 102. The user device(s) 102 can include one or more mobile devices (e.g., one or more mobile phones, one or more smart phones, one or more other cellular phones, one or more of any other types of mobile devices, or any combination thereof), one or more personal digital assistants (PDAs), one or more personal computers (PCs) (e.g., one or more laptops, one or more desktops, one or more workstations, one or more media players, one or more tablets, one or more gaming devices, one or more any other types of PCs, or any combination thereof), one or more glasses (e.g., one or more computer-altered reality glasses, one or more extended reality (XR) glasses, one or more augmented reality (AR) glasses, one or more virtual reality (VR) glasses, one or more mixed reality (MR) glasses, or one or more of any other types of electronic glasses), one or more smart watches, one or more hotspots, one or more of any other types of computing or communication devices, or a combination thereof.

The network environment 100 can include one or more networks, which can include a service provider network 104, a service provider cloud network 106, an external network 108, one or more of any other types of networks, or any combination thereof. In some examples, the user device(s) 102 can be communicatively coupled to the service provider network 104, the service provider cloud network 106, the external network 108, the other type(s) of networks, or any combination thereof.

While the network(s) can include the external network 108 as discussed above in the current disclosure, it is not limited as such. In some examples, the network(s) can include one or more of various types of networks (e.g., one or more public networks) (e.g., one or more decentralized overlay networks, one or more public cloud overlay networks, any other types of external networks, or a combination thereof), which can be utilized to implement the external network 108 for purposes of implementing any of the techniques as discussed herein.

While the service provider network 104, the service provider cloud network 106, the external network 108, and the other type(s) of network(s) can be separate from one another, as discussed above in the current disclosure, it is not limited as such. In some examples, the service provider network 104, the service provider cloud network 106, the external network 108, and/or the other type(s) of network(s) can be combined, and/or integrated together in one or more of any networks or any type, and utilized as the service provider network 104, the service provider cloud network 106, the external network 108, the other type(s) of network(s), or a combination thereof, for purposes of implementing any of the techniques as discussed herein.

In various examples, one or more of any of the service provider network 104, the service provider cloud network 106, the external network 108, or the other type(s) of networks can include fifth generation (5G) networks. In those or other examples, the user device(s) 102 can be operated utilizing computer-altered reality technologies, which can include an XR technology. In those or other examples, the computer-altered reality technologies and/or the XR technology can include an AR technology, a VR technology, an MR technology, or a combination thereof.

In various implementations, the computer-altered reality data, which can include XR data being utilized for operation of the user device(s) 102, can be associated with one or more user profiles of one or more users of the mobile device(s) 102. The computer-altered reality data being utilized for operation of the user device(s) 102 can be rendered at one or more different locations of the network(s).

Portions of various types of the computer-altered reality data requiring relatively faster rendering can be rendered relatively closer to the user device(s). Portions of various types of the computer-altered reality data not requiring relatively faster rendering can be rendered relatively further from the user device(s). The different network location(s) can enable the computer-altered reality data to be efficiently rendered by selecting network locations closer to the user device(s) for rendering different portions of different types of data in such a way as to ensure optimal operation of the user device(s) and/or make the operation of the user device(s) more robust.

While the location based rendering can be performed utilizing the computer-altered reality data, which can include the XR data, as discussed throughout the current disclosure, it is not limited thereby. In some examples, one or more of any types of data (e.g., one or more of any types of computer-altered reality data) can be utilized in a similar way as any of the computer-altered reality data and/or the XR data for purposes of implementing any of the techniques discussed herein. In those or other examples, one or more of any types of rendered data (e.g., one or more of any types of rendered computer-altered reality data) can be utilized in a similar way as any of the rendered computer-altered reality data and/or the rendered XR data for purposes of implementing any of the techniques discussed herein In various instances, the location based rendering according to the techniques discussed herein provide various advantages in comparison to convention technology. For example, the location based rendering being performed according to the techniques discussed herein enable the computer-altered reality data (e.g., XR data) to be rendered more efficiently, effectively, and successfully, than in existing systems.

The computer-altered reality data can be rendered utilizing rendering information. In various examples, one or more sets (e.g., one or more computer-altered reality data sets associated with one or more items, respectively) of the computer-altered reality data can be rendered utilizing one or more sets of the rendering information, respectively. In some examples, individual ones the set(s) of the computer-altered reality data may be associated with individual ones of one or more corresponding items (e.g., one or more corresponding items being represented by the computer-altered reality data). In those or other examples, individual ones of one or more portions of the computer-altered reality data may include at least one of the set(s) of the computer-altered reality data. For example, a set of the computer-altered reality data can include and/or represent a discrete item (e.g., a discrete object) (e.g., a 3D model, such as a model of a building, an asset of an object, etc.).

In various examples, the rendering information can include rendering location information associated with the location(s) of the network(s) utilized to render the computer-altered reality data. In those or other examples, the rendering location information can identify the network location(s) utilized to rendering the computer-altered reality data. In those or other examples, the rendering location information can include one or more identifiers (or “network location identifier(s)”) associated with the network location(s).

In some examples, the network location identifier(s) can include an identifier associated with the service provider network 104, an identifier associated with the service provider cloud network 106, an identifier associated with the external network 108, and/or one or more other identifiers associated with the other type(s) of networks, respectively. In those or other examples, the network location identifier(s) can include an identifier associated with an edge (or “edge network”)) of the network(s), an identifier associated with a near-edge (or “near-edge network”) of the network(s), an identifier associated with a mid-edge (or “mid-edge network”) of the network(s), an identifier associated with a far-edge (or “far-edge network”) of the network(s), one or more other identifiers associated with other portions of the network(s), or any combination thereof.

In some examples, the network location(s) can include a location (e.g., one or more networks) associated with the edge network, a location (e.g., one or more networks) associated with the near-edge network, a location (e.g., one or more networks) associated with the mid-edge network, a location (e.g., one or more networks) associated with far-edge network, one or more other locations (e.g., one or more other networks) associated with other portions of the network(s), or any combination thereof. In additional or alternative examples, the network location associated with the edge network can include one or more severs associated with the edge network, the network location associated with the near-edge network can include one or more severs associated with the near-edge network, the network location associated with the mid-edge network can include one or more severs associated with the mid-edge network, the network location associated with the far-edge network can include one or more severs associated with far-edge network, the one or more other networks can include one or more other servers associated with other portions of the network(s), or any combination thereof.

In some examples, the rendering information can include network category information (or “network classification information”), with which the network location information may be associated. In those or other examples, the network category information can include one or more network category identifiers (or “network classification identifier(s)”) associated with one or more categories (or “network classification(s)”) of the network(s), respectively.

While the network category information can be included in the rendering information as discussed above in the current disclosure, it is not limited as such. In some examples, the network category information can be included in the network location information, can be separate from the network location information, and/or can include the network location information. In those or other examples, the network location(s) utilized to render the computer-altered reality data can be identified based on the network location and/or the network category information.

In some examples, the category (ies) can include a local network category associated with a local network (e.g., any of the user device(s) 102, a local network portion of the network(s)), and/or an edge network category associated with the edge network (e.g., an edge network portion of the network(s)). In those or other examples, the local network and the edge network can be separate from one another (e.g., the local network can be at a different distance, such as a closer distance, from a user device as the edge network), or any portion of the local network can include and/or be a same portion as any portion of the edge network.

In those or other examples, the network(s) can include the local network category (or “local network”) (or “local”), and/or the edge network category (or “edge network”) (or “edge”) 110, being associated with the edge network (e.g., the edge network, which may be associated with, included in, and/or composed of the service provider network 104, the service provider cloud network 106, the external network 108, or a combination thereof). For instance, with examples of the local or edge 110 being associated with the service provider network 104 and/or the service provider cloud network 106, a network location associated with the local or edge 110 may be represented as a portion of the network at a side (e.g., a near side, with respect to the user device(s) 102) of a dotted line separating the local or edge 110 and the near-edge 112, as illustrated in FIG. 1.

In some examples, the edge network may include a portion of a network associated with edge computing. In those or other examples, the edge computing associated with the network(s) may include the network(s) being operated according to a distributed computing paradigm that “brings” computation and data storage (e.g., at least one portion of the rendering of, and any associated computations and/or data storage for rendering of the computer-altered reality data) closer to at least one device (e.g., at least one of the user device(s) 102) utilizing the data.

In those or other examples the category (ies) can include a near-edge network category (or “near-edge network”) (or “near-edge”) 112 associated with the near-edge network (e.g., the near-edge network, which may be associated with, included in, and/or composed of, the service provider network 104, the service provider cloud network 106, the external network 108, or a combination thereof). For instance, with examples of the near-edge 112 being associated with the service provider cloud network 106 and/or the external network 108, a network location associated with the near-edge 112 may be represented as a portion of the network at between the dotted line separating the local or edge 110 and the near-edge 112, and a dotted line separating the near-edge 112 and the mid-edge 114, as illustrated in FIG. 1.

In some examples, the category (ies) can include a mid-edge network category (or “mid-edge network”) (or “mid-edge”) 114 associated with the mid-edge network (e.g., the mid-edge network, which may be associated with, included in, and/or composed of, the service provider network 104, the service provider cloud network 106, the external network 108, or a combination thereof). For instance, with examples of the mid-edge 114 being associated with the service provider cloud network 106 and/or the external network 108, a network location associated with the mid-edge 114 may be represented as a portion of the network at between the dotted line separating the near-edge 112 and the mid-edge 114, and a dotted line separating the mid-edge 114 and the far-edge 116, as illustrated in FIG. 1.

In those or other examples the category (ies) can include a far-edge network category (or “far-edge network”) (or “far-edge”) 116 associated with far-edge network (e.g., the far edge network, which may be associated be associated with, included in, and/or composed of, the service provider network 104, the service provider cloud network 106, the external network 108, or a combination thereof). For instance, with examples of the far-edge 116 being associated with the external network 108, a network location associated with the far-edge 116 may be represented as a portion of the network at a side (e.g., a far side, with respect to the user device(s) 102) of a dotted line separating the mid-edge 114 and the far-edge 116, as illustrated in FIG. 1.

The network category (ies) can be indicated and/or identified by identifiers (or “network category identifier(s)). In some examples, the edge network and/or the local or edge network category can be indicated and/or identified by a local or edge network category identifier. In those or examples, the near-edge network and/or the near-edge network category can be indicated and/or identified by a near-edge network category identifier. In those or examples, the mid-edge network and/or the mid-edge network category can be indicated and/or identified by a mid-edge network category identifier. In those or examples, the far-edge network and/or the far-edge network category can be indicated and/or identified by a far-edge network category identifier.

A distance (e.g., a first distance) between the local or edge 110 and the user device(s) 102 may be less than a threshold distance. A distance (e.g., a second distance) between the near-edge 112 and the user device(s) 102 may be less than a threshold distance (e.g., the threshold distance associated with the near-edge 112 being greater than or equal to the threshold distance associated with the local or edge 110). A distance (e.g., a third distance) between the mid-edge 114 and the user device(s) 102 may be less than a threshold distance (e.g., the threshold distance associated with the mid-edge 114 being greater than or equal to the threshold distance associated with the near-edge 112). A distance (e.g., a fourth distance) between the far-edge 116 and the user device(s) 102 may be less than a threshold distance (e.g., the threshold distance associated with the far-edge 116 being greater than or equal to the threshold distance associated with the mid-edge 114).

In various examples, a location of the service provider cloud network 106 associated with the mid-edge 114 may be further from the user device(s) 102 than a location of the service provider cloud network 106 associated with the near-edge 112. In those or other examples, a distance between the location of the service provider cloud network 106 associated with the mid-edge 114, and the user device(s) 102 may be greater than or equal to a distance between the location of the service provider cloud network 106 associated with the near-edge 112, and the user device(s) 102. For example, the distance between the location of the service provider cloud network 106 associated with the near-edge 112, and the user device(s) 102, can include a distance being identified between a location of a server at the near-edge 112, and a location of a user device (e.g., any of the user device(s) 102).

In various examples, a location of the external network 108 associated with the mid-edge 114 may be further from the user device(s) 102 than a location of the external network 108 associated with the near-edge 112. In those or other examples, a distance between the location of the external network 108 associated with the mid-edge 114 and the user device(s) 102 may be greater than or equal to a distance between the location of the external network 108 associated with the near-edge 112, and the user device(s) 102.

While the local or edge 110, the near-edge 112, the mid-edge 114, and the far-edge 116 can be utilized at the various network location(s) to render the computer-altered reality data as discussed above in the current disclosure, it is not limited as such. In some examples, the local or edge 110 can include, and/or be included in, one or more of any of the network(s) of the network environment 100; the near-edge 112 can include, and/or be included in, one or more of any of the network(s) of the network environment 100; the mid-edge 114 can include, and/or be included in, one or more of any of the network(s) of the network environment 100; and/or the far-edge 116 can include, and/or be included in, one or more of any of the network(s) of the network environment 100. In those or other examples, the local or edge 110, the near-edge 112, the mid-edge 114, and the far-edge 116 can include, and/or be included in, one or more portions of one or more of any of the networks of the network environment 100.

The locations utilized to render the computer-altered reality data can be identified based on the rendering oriented characteristic data (or “characteristic data”) (or “characteristics data”) and/or priority information (or “characteristic data priority information”) (or “characteristics data priority information”). The priority information, which can be identified based on the characteristic data, as discussed below in further detail, can include one or more priorities (or “category (ies)”) (or “data category (ies)”) (or “item category (ies)”) (or “item classification(s)”) (e.g., one or more object categories (or “object classification(s)”)) associated with the computer-altered reality data. By identifying the priority (ies) associated with the computer-altered reality data, one or more portions of the computer-altered reality data being of a relatively higher priority can be rendered more quickly, and/or closer to the user device(s) 102, with respect to one or more portions of the computer-altered reality data being of a relatively lower priority.

By managing the network location(s) utilized for the computer-altered reality data rendering, experiences of one or more users operating the user device(s) 102 may be improved. The experiences of the user(s) operating the user device(s) 102 may be improved based on presentation by the user device(s) 102 of the rendered computer-altered reality data being accomplished more smoothly and/or with fewer delays, particularly with respect to one or more items (e.g., one or more objects) associated with relatively higher levels of interactivity (or “interaction”) (e.g., relatively higher levels of interactivity associated with the item(s) and/or the user(s)) and/or with respect to one or more items (e.g., one or more objects) with relatively higher levels of motion. In various examples, the interactivity (e.g., item and/or user interactivity) can include item-item interactivity (e.g., interactivity between at least one of various ones of the item(s) and at least one other of various ones of the item(s)), user-item interactivity (e.g., interactivity between at least one of any of various ones of the user(s) and/or at least one of any of various ones of the item(s)) (e.g., interactivity including a game object being held/grabbed “by a user” so that the object may become part of the “protagonist,” such as with cases in which related computer-altered reality data set(s) associated with the object and/or the user are prioritized as the “first priority,” as discussed below) (e.g., interactivity including an object being touched (e.g., but not held) “by a user,” such as with cases in which related computer-altered reality data set(s) associated with the item and/or the user are prioritized as the “first priority” and/or the “second priority,” as discussed below, based on a position, a resolution, and/or other characteristic data associated with the object and/or the user), and so on, or any combination thereof.

The priority (ies) associated with the computer-altered reality data can be identified, (e.g., identified, determined, generated, modified, and so on, or any combination thereof), based on characteristic data. The characteristic data can include one or more characteristics associated with the item(s) (e.g., the object(s)) associated with (e.g., represented via) the computer-altered reality data. The characteristic data can include location data (or “user device location data”) (e.g., one or more locations identifiers indicating one or more locations of the user device(s) 102, which may be identified in various ways, such as based on information identified by, and/or received from, any of the network(s)) and one or more capabilities (or “characteristic(s)”) (one or more screen resolutions, one or more refreshment rates, one or more frame rates, one or more user control inputs, and so on, or any combination thereof) associated with the user device(s) 102. In some examples, characteristic data associated with, and/or indicating, the characteristic(s), can be identified and/or utilized to identify the priority (ies). The characteristic data can be associated with, and identified based on, the computer-altered reality data.

In some implementations, the characteristic data can include interactivity data (or “interaction data”) (e.g., item interactivity data, object interactivity data, user interactivity data, user manipulability/interactivity data and so on, or any combination thereof) associated with the portions and/or the set(s) of the computer-altered reality data. Utilizing the interactivity data (e.g., the item and/or user interactivity data) may enable one or more optimal rendering location selections in anticipation of one or more priority changes due to one or more selections (or “user selections”) (e.g., one or more selections, which can be received via user input to the user device(s) 102) and/or one or more interactions (or “user interactions) (e.g., one or more interactions, which can be associated with the user(s) of the user device(s) 102).

The priority (ies) can include relatively higher priorities associated with the portion(s) of the computer-altered reality data (e.g., at least one of the computer-altered reality data set(s)) having relatively higher levels of interactions (e.g., item and/or user interactions, such as item-item interactions, user-item interactions etc., or any combination thereof, which may be of a relatively higher level) and/or relatively higher levels of motion (e.g., motion associated with an item and/or a portion of an item, which may be of a relatively higher level). The priority (ies) can include relatively lower priorities associated with the portion(s) of the computer-altered reality data (e.g., at least one of the computer-altered reality data set(s)) having relatively lower levels of interactions (e.g., item and/or user interactions, such as item-item interactions, user-item interactions etc., or any combination thereof, which may be of a relatively lower level), and/or relatively lower levels of motion. (e.g., motion associated with an item and/or a portion of an item, which may be of a relatively lower level).

Priority information, which can include, indicate, and/or identify the priority (ies), and/or rendering location information, can be identified based on motion data (e.g., data including, indicating, and/or identifying the level(s) of motion), interactivity data (e.g., data including, indicating, and/or identifying the level(s) of interactivity), complexity data (e.g., data including, indicating, and/or identifying one or more levels of complexity for performing rendering), device data (e.g., data including, indicating, and/or identifying one or more levels of device characteristics associated with the user device(s) 102), or any combination thereof. In some examples, the complexity data may include the device data, or vice versa.

The complexity data (e.g., complexity data associated with any of the computer-altered reality data set(s) associated with any corresponding one of the item(s)), may include or more levels of illumination, one or more numbers of polygons, one or more secondary rate reflections, one or more levels and/or sources of global illumination, etc. of The device data (e.g., device data associated with any of the computer-altered reality data set(s) associated with any corresponding one of the item(s)) may include one or more levels of device resolution (e.g., one or more levels of resolution associated with any of the user device(s) 102, one or more levels of resolution associated with a display of any of the user device(s) 102, etc.), one or more frame rates (e.g., one or more frame rates associated with any rendering of data to be utilized by the user device(s) 102), and/or one or more refreshment rates (e.g., one or more refreshment rates associated with any of the user device(s) 102).

Although the priority (ies) and/or the rendering location(s) can be identified based on various types of data, such as the motion data, the interactivity data, the complexity data, and the device data, and the term “priority (ies)” is utilized for purposes of convenience and explanation, as discussed above in the current disclosure, it is not limited as such. In various examples, the priority information, and/or rendering location information, can be identified and utilized in a similar way as the priority (ies), and/or the rendering location(s), as discussed above, for purposes of implementing any the techniques discussed throughout the current disclosure. In some examples, the characteristic data, which can be utilized to identify the priority information, and/or rendering location information, can include any of the motion data, the interactivity data, the complexity data, the device data, one or more of other types of characteristic data, or any combination thereof. In those or other examples, any of the characteristic data (e.g., the characteristic(s)), such as the motion data (e.g., one or more motion characteristics), the interactivity data (e.g., one or more interactivity characteristics), and/or the complexity data (e.g., one or more complexity characteristics associated with one or more resolutions, one or more frame rates, one or more refreshment rates, one or more polygon counts, one or more item sizes, etc.), can be utilized for identifying the priority information (e.g., the priority (ies) and/or rendering location information (e.g., the rendering location(s)).

The priority (ies) can be identified using metrics information (or “characteristic data metrics information”). The metrics information can include one or more metrics being identified based on the characteristic data and the computer-altered reality data. In various implementations, the metric(s) can include one or more measurement values (e.g., one or more measurement results) representing one or more levels of the characteristic(s), respectively. In some examples, the metric(s) can include individual metric(s) for individual characteristic(s) (e.g., the metric(s) can include a single metric associated with a single characteristic (e.g., an item and/or user interactivity metric (or “an item and/or user interaction metric”) associated with an item and/or user interactivity associated with a portion (e.g., a partial or entire portion) of an item) (e.g., a motion metric associated with a motion of a portion (e.g., a partial or entire portion) of an item) (e.g., a complexity metric associated with any of the complexity data, such as a level of illumination metric associated with a level of illumination, a number of polygons metric associate with a number of polygons, a secondary rate reflection metric associated with a secondary rate reflection, a level and/or source of global illumination metric associated with a level and/or source of global illumination, etc.) (e.g., a device data metric associated with any of the device data, such as a resolution metric associated with a resolution, a frame rate metric associate with a frame rate, a refreshment rate metric associated with a refreshment rate, etc.). In those or other examples, the metric(s) can include at least one metric associated with a single characteristic (e.g., multiple metrics can represent separate movements of different portions of an item, such as individual and separate motion metrics for individual and separate legs of an animal, etc.).

In those or other examples, the metric(s) can include a metric (e.g., an aggregated metric) associated with at least one characteristic associated with an item (e.g., the at least one metric associated with at least one corresponding portion of the item can be aggregated to generate a single metric, as an aggregated metric, associated with the item). For example, the aggregated metric(s) can include an aggregated interactivity metric, an aggregated motion metric, etc., for an item, and/or an aggregated metric associated with interactivity, motion, or any combination thereof. In such an example, or in another example, an aggregated interactivity metric can be associated with a combination of one or more interactivity metrics associated with an item and/or a user interactivity; an aggregated motion metric can be associated with a combination of one or more motion metrics associated with an item motion, an item and/or user interactivity, etc. In such an example, or in another example, an interactivity metric can be associated with, and/or can represent a measurement of, any of the interactivity (ies) associated with an item and/or a user; a motion metric can be associated with, and/or can represent a measurement of, any motion of an item, etc.

While various metrics (e.g., single metrics, aggregated metrics, etc.) can be utilized as discussed above in the current disclosure, it is not limited as such. One or more of any types of metrics can be identified (e.g., generated) based on any combination of item characteristics and utilized to implement any techniques as discussed herein.

As a hypothetical example, individual ones of the set(s) (e.g., any of the set(s) of the portion(s) of the computer-altered reality data) of the computer-altered reality data can be associated with an item (e.g., a first item), the priority (ies) can include a priority (e.g., a first priority being a “first highest priority”) associated with the first item based on a level of interactivity (e.g., a first level of item and/or user interactivity being “highly interactive”) associated with the first item and a level of motion (e.g., a first level of motion being “fast motion”) associated with the first item. The first item, for example, can include an item representing a user of a user device 102, the user being located in an environment (or “real world environment”). In various implementations, the first priority can be associated with a “first-person view,” by an item (e.g., a user) of a same item (e.g., a same user, a portion of a same user, etc.). In some examples, the first priority can be associated with at least one of the item(s) being rendered by the local or edge 110 (e.g., rendering being performed at a round trip time (RTT) (e.g., an over the air (OTA) RTT) of 20 ms or less).

In the hypothetical example, the priority (ies) can include a priority (e.g., a second priority being a “second highest priority”) associated with a second item based on a level of interactivity (e.g., a second level of item and/or user interactivity being “interactive,” the second level of item and/or user interactivity being, in some cases, of an equivalent type, as the first level of item and/or user interactivity) associated with the second item and a level of motion (e.g., a second level of motion being “auto-motion”) associated with the second item. For example, auto-motion can include one or more motions of any of the item(s) (e.g., any of the object(s)) reacting to “physics” (e.g., one or more collisions), resulting in one or more changes in motion. The second item, for example, can include an item (e.g., an avatar associated with a “player” and/or a “protagonist”) representing another item (e.g., another user of another user device 102), the other user being located in the environment, the other user being relatively near to the user (e.g., relatively near to the user device of the user), with the user interacting frequently with the other user (e.g., although with a level of interaction being less than or equal to a level of interaction for the first item), or any combination thereof. In various implementations, the second priority can be associated with a “third-person view,” by an item (e.g., a user) and of a different item (e.g., a different item and/or a different user). In some examples, the second priority can be associated with at least one of the item(s) being rendered by the near-edge 112 (e.g., rendering being performed at an RTT of 60 ms or less).

In the hypothetical example, the priority (ies) can include a priority (e.g., a third priority being a “third highest priority”) (or “third category”) associated with a third item. The third priority can be based on a level of interactivity (e.g., a third level of item and/or user interactivity being “interactive,” the third level of item and/or user interactivity being, in some cases, of an equivalent type, as the first level and/or second level of item and/or user interactivity) associated with the third item and a level of motion (e.g., a third level of motion being “slow motion”) associated with the third item. In various implementations, the third priority can be associated with a “third-person view,” by an item (e.g., a user) and of a different item (e.g., a different item and/or a different user). The third item, for example, can include another item being located in the environment, the other item being relatively far from the user (e.g., relatively far from the user device of the user), with the user interacting frequently with the other user (e.g., although with a level of interaction being less than or equal to a level of interaction for the first item), or any combination thereof.

In the hypothetical example, the third priority can be associated with a fourth item based on a level of motion (e.g., a fourth level of motion being “auto-motion,” the fourth level of motion being, in some cases, of an equivalent type as the second level of motion) associated with the fourth item. The fourth item, for example, can include an item (e.g., a “background” item, including a non-player character (or “NPC”,” a bot (e.g., an item not under user control), etc.), an item in a portion of a background of an environment), an item (e.g., an animal), in a relatively nearer portion of the background, an item with which the user may not be interacting, etc.), which may be in the background of the environment. The fourth item, for example, can include an item representing an animal (e.g., the animal, which may be near to the user and/or relatively near to the user device of the user) (e.g., the animal, with which the user may interacting occasionally) in the environment.

In various implementations, the third priority can be associated with a “third-person view,” by an item (e.g., a user) of a different item (e.g., a different item and/or a different user). In some example, the third priority can be associated with at least one of the item(s) being rendered by the mid-edge 114 (e.g., rendering being performed at an RTT of 100 ms or less).

In the hypothetical example, the priority (ies) can include a priority (e.g., a fourth priority being a “fourth highest priority”) associated with a fifth item based on a level of interactivity (e.g., a fifth level of item and/or user interactivity being “non-interactive”) associated with the fifth item and a level of motion (e.g., a fifth level of motion being “stationary” or “slow.” the fifth level of motion being, in some cases, of an equivalent type as, or a different type from, the third level of motion) associated with the item. The fifth item, for example, can include an item (e.g., a “background” item, including any of the item(s) being relatively far away (e.g., faraway objects) (e.g., an NPC), (e.g., a bot) (e.g., an item not under user control, etc.). The sixth item can represent any of the item(s) in the background of the environment with the user not interacting with the animal), such as one or more clouds or one or more airplanes in the sky. The fourth priority can be associated with at least one of the item(s) being rendered by the far-edge 116 (e.g., rendering being performed at an RTT between 100 ms and 150 ms).

In the hypothetical example, certain combinations of the interactivity (ies) and the motion(s), for example, may be associated with corresponding priorities. For instance, at least one metric indicating an item is associated with a player and/or a protagonist, the item is associated with a “first-person view,” the item is “highly interactive,” and the item has “fast motion” may be utilized to classify the item as a “first priority item” to be rendered at the local or edge 1110 at an RTT of less than 20 milliseconds. Alternatively or additionally, at least one metric indicating an item is associated with a player and/or a protagonist, the item is associated with a “third-person view,” the item is relatively near to the user device 102 (e.g., the item is relatively close to a camera of the user device 102), the item is “interactive,” and the item has “auto-motion” may be utilized to classify the item as a “second priority item” to be rendered at the near-edge 112 at an RTT of less than 60 milliseconds.

Alternatively or additionally, at least one metric indicating an item is associated with a player and/or a protagonist, the item is associated with a “third-person view,” the item is relatively far from the user device 102 (e.g., the item is relatively far from a camera of the user device 102), the item is “interactive,” and the item has “slow motion” may be utilized to classify the item as a “third priority item” to be rendered at the mid-edge 114 at an RTT of less than 100 milliseconds. Alternatively or additionally, at least one metric indicating an item is associated with a background an NPC, or a bot, the item is relatively near to the user device 102 (e.g., the item is relatively near to a camera of the user device 102), and the item has “auto-motion” may be utilized to classify the item as a “fourth priority item” to be rendered at the mid-edge 114 at an RTT of less than 100 milliseconds. Alternatively or additionally, at least one metric indicating an item is associated with a background an NPC, or a bot, the item is relatively far from the user device 102 (e.g., the item is relatively far from a camera of the user device 102), and the item is stationary or has “slow-motion” may be utilized to classify the item as a “fifth priority item” to be rendered at the far-edge 116 at an RTT of greater than 100 milliseconds and less than 105 milliseconds.

Although various metrics associated with various characteristics, such as interactivity and/or motion, may be associated with, and/or utilized to select locations for rendering, various sets of computer-altered reality data, as discussed above in the current disclosure, it is not limited as such. In some examples, any additional network locations of any number can be utilized to render any of the set(s) of computer-altered reality data based on any types of metric(s) associated with any of the characteristic(s) of various types.

The portion(s) (e.g., the set(s)) of the computer-altered reality data can be analyzed to identify the characteristic data. In some examples, the computer-altered reality data being analyzed can include one or more computer generated portions (e.g., the computer-altered reality data set(s) associated with the item(s) and/or the object(s)) of the computer-altered reality data. In those or other examples, the computer-altered reality data being analyzed can include one or more portions of environment data (e.g., data associated with the environment in which the user(s) of the user device(s) are located), one or more other portions of one or more other types of data, or any combination thereof. In those or other examples, the portion(s) of the environment data can include one or more environment items (or “real world item(s)”) (e.g., one or more environment objects (or “real world object(s)”)) of the real world environment.

In those or other examples, the characteristic data can be identified (e.g. identified, determined, generated, modified, etc., or any combination thereof) based on, and/or can include, user selection data and/or activity data. In some examples, the user selection data can include data associated with the user selection(s), which can be received via the user input to the user device(s) 102 (e.g., the user selection data can identify and/or indicate the user selection(s)). For example, the selection(s) can be received via user input including touch input, speech input, haptic input, motion input, gaze input, hand gesture input, any other type of input, or any combination thereof.

In some examples, the activity data can be associated with activity of the user(s) of the user device(s), activity associated with the computer-altered reality data (e.g., activity of one or more of any of the portion(s) (e.g., the set(s)) of the computer-altered reality data), activity associated with any other type of data, any of the device(s), and/or any of the server(s), associated with the network environment 100 and/or an environment in which the user(s) are located, or any combination thereof. In those or other examples, the activity data can include various types of activity (e.g., any of one or more types of activity associated with any of the portion(s) of the computer-altered reality data) (e.g., activity associated with any corresponding ones of the computer-altered reality data portion(s)) (e.g., activity associated with the set(s) of the computer-altered reality data, such as activity associated with any corresponding ones of the computer-altered reality data set(s)).

Individual ones of one or more portions of the characteristic data can include one or more sets of the characteristic data. Individual ones of the characteristic data set(s) can include one or more characteristics. Individual ones of the characteristic data set(s) can be associated with individual ones of the set(s) of the computer-altered reality data.

The characteristic data (e.g., the characteristic(s)) can include one or more identifiers (e.g., one or more computer-altered reality data set identifiers, one or more computer-altered reality data item identifiers, one or more computer-altered reality data object identifiers, one or more environment item identifiers (or “real world item identifier(s),” one or more environment object identifiers (or “real world object identifier(s)”), etc., or any combination thereof). For example, a characteristic data set can include a computer-altered reality data set identifier, a computer-altered reality data item identifier, a computer-altered reality data object identifier, an environment item identifier, an environment object identifier, and so on, or any combination thereof. The identifier(s) can be associated with the set(s) of the computer-altered reality data, respectively. For example, a computer-altered reality data item identifier can be associated with an item, with which a set of the computer-altered reality data may be associated.

The portions of the characteristic data, by which the metric(s) may be identified (e.g., generated, detected, measured, modified, etc.), can include, identify, and/or indicate the characteristic(s). The characteristic(s), by which the metric(s) may be identified, can include the user selection(s), the interaction(s) (e.g., one or more interaction(s) associated with the item(s) and/or the user(s), such as one or more of the item and/or the user interaction(s) associated with the item(s), respectively), the motion(s) of the item(s) (e.g., user motion, computer generated item motion, environment item motion, etc., or any combination therefor), the activity (ies) (e.g., item and/or user activity, computer generated item activity, environment item activity, etc., or any combination therefor) associated with the item(s), respectively, etc.

As a hypothetical example, such as with a set of the computer-altered reality data being associated with an object (e.g., an animal) (e.g., a computer generated animal), characteristic data associated with the computer-altered reality data set can be identified. Identifying the characteristic data can include identifying one or more characteristics associated with the set of the computer-altered reality data, which may be associated with the animal. Identifying the characteristic data including identifying a computer-altered reality data set identifier (e.g., an identifier of the computer-altered reality data set associated with the animal), at least one item and/or user interactivity associated with the computer-altered reality data set, at least one motion associated with the computer-altered reality data set, at least one other characteristic associated with the computer-altered reality data set, or any combination thereof.

In the hypothetical, the characteristic data can include an identifier (or “animal identifier”) associated with the animal. The identifier of the animal can be utilized to identify the animal with which the characteristic(s) are associated, and/or to identify the characteristic(s) of the animal. The animal identifier can be utilized for purposes of identifying a rendering location for the “animal” (e.g., identifying a rendering location for the computer-altered reality data set associated with the animal) and/or for performing rendering of the “animal” (e.g., performing rendering of the computer-altered reality data set associated with the animal).

In the hypothetical example, the portion(s) of the characteristic data can include an item and/or user interactivity characteristic (or “item and/or user interactivity”) and a motion characteristic (or “motion”). The item and/or user interactivity can include activity represented by interactivity data in the characteristic data, the interactivity data including, for example, user interactivity data associated with the user briefly reaching out a hand to slowly touch (e.g., pet) the animal. The motion can include motion represented by motion data in the characteristic data, the motion data indicating, for example, the animal moving slightly (e.g., remaining mostly stationary as the user pets the animal).

In the hypothetical example, the metric(s) and the priority (ies) can be identified (e.g., generated). The metric(s) can include an interactivity metric (e.g., an item and/or user interactivity metric) indicating a level of interactivity (e.g., a level of an item and/or user interactivity) (e.g., a moderate level of interactivity), and a motion metric indicating a level of motion (e.g., a relatively low level of motion). The priority (ies) can include a third highest priority based on the interactivity metric indicating the level of interactivity (e.g., the second and/or the third “interactive” level of interactivity) associated with the animal, and/or the level of motion (e.g., the third “slow motion” level of motion) associated with the animal.

In some examples, the priority utilized to render the “animal” can be determined, in some cases, based on at least one of the interactivity metric(s) indicating whether the animal is associate with a “first-person view” or a “third-person view,” and/or whether the animal is near to, or far from, the user device 102. In those or other examples the priority utilized to render the “animal” can be determined, in some cases, based on any complexity data and/or any device data, which can include at least one resolution, at least one frame rate, and/or at least one refreshment rate, etc., associated with a user device 102 to be utilized to display a set of computer-altered reality data associated with the “animal.”

In those or other examples, any of the complexity data and/or the device data can be utilized to “upgrade” or “downgrade” any priority to another priority (e.g., a lower priority or a higher priority). In various implementations, the modified priority (e.g., upgraded priority, downgraded priority, etc.) can be identified for initially selecting a priority (e.g., performing an initial selection of a priority based on any information (e.g., information received from a developer, etc.) identified utilizing motion data (e.g., whether the item is initially in motion of some type or is stationary), complexity data, device data, interactivity data, position data (e.g., initial positions) (e.g., whether the item is initially relatively near or relatively far from the user device 102), etc., or any combination thereof). In alternative or additional implementations, the modified priority (e.g., upgraded priority, downgraded priority, etc.) can be identified for modifying/changing a priority (e.g., modifying a selection of a priority) based on any information identified utilizing motion data, complexity data, device data, interactivity data, position data, etc., or any combination thereof, based on any previously identified priority (e.g., a subsequent selection of a priority can be performed utilizing the motion data, the complexity data and/or the device data, the interactivity data, etc., or any combination thereof).

In alternative or additional implementations, any of the initial priority(ies) can be identified based on prediction data and/or anticipation data indicating one or more subsequent priorities (e.g., one or more possible subsequent priorities).

The network environment 100 can include various numbers of servers associated with individual ones of the network location(s). In some examples, the network environment 100 can include one or more servers (or “local or edge servers”) (or “edge server(s)) 118 associated with the service provider cloud network 106 and/or the local or edge 110. The edge server(s) 118 can be at a network edge location.

In those or other examples, the network environment 100 can include one or more servers (or “near-edge server(s)”) 120 associated with the service provider cloud network 106 and/or the near-edge 112. In those or other examples, the network environment 100 can include one or more servers (or “mid-edge server(s)”) 122 associated with the service provider cloud network 106 and/or the mid-edge 114.

In those or other examples, the network environment 100 can include one or more servers (or “near-edge server(s)”) 124 associated with the external network 108 and/or the near-edge 112. The near-edge server(s) 124 can be at a network near-edge location. In those or other examples, the network environment 100 can include one or more servers (or “mid-edge server(s)”) 126 associated with the external network 108 and/or the mid-edge 114. The mid-edge server(s) 126 can be at a network mid-edge location. In those or other examples, the network environment 100 can include one or more servers (or “far-edge server(s)”) 128 associated with the external network 108 and/or the far-edge 116. The far-edge server(s) 128 can be at a network far-edge location.

In various implementations, the user device(s) 102 can exchange one or more communications with the local or edge 110 (e.g., the server(s) 118), the near-edge 112 (e.g., the server(s) 120 and/or the server(s) 124), the mid-edge 114 (e.g., the server(s) 122 and/or the server(s) 126), the far-edge 116 (e.g., the server(s) 128), or any combination thereof. In some examples, the user device(s) 102 can exchange computer-altered reality data (e.g., XR data) 130 with the server(s) 118. In those or other examples, the XR data 130 exchanged between the user device(s) 102 and the server(s) 118 can include XR data 130 of one or more priorities (e.g., first-fourth priorities).

In some examples, the computer-altered reality data exchanged between the server(s) 118, and the server(s) 120 and/or 124 can include XR data 132 and/or 134, respectively. In those or other examples, the computer-altered reality data exchanged between the server(s) 118, and the server(s) 122 and/or 126, can include XR data 136 and/or 138, respectively. In those or other examples, the computer-altered reality data exchanged between the server(s) 118 and the server(s) 128 can include XR data 140.

In various examples, the XR data 130, which can include the XR data utilized by the user device(s) 102, can be of one or more priorities (e.g., the first-fourth priorities) as referenced above in any of the hypothetical examples). In those or other examples, the XR data 130 can include the XR data of a priority (e.g., the first priority), being higher than a priority (e.g., the second priority) of the XR data 132 and/or 134. In those or other examples, the XR data 130 can include the XR data 132 and/or 134 of a priority (e.g., the second priority), being higher than a priority (e.g., the third priority) of the XR data 132 and/or 134.

In those or other examples, the XR data 130 can include the XR data 136 and/or 138 of a priority (e.g., the third priority), being higher than a priority (e.g., the fourth priority) of the XR data 140. In those or other examples, the XR data 130 can include the XR data 140 of the priority (e.g., the fourth priority) being less than the priorities of the XR data 132-138.

In various implementations, the server(s) 118 can be utilized to manage the XR data at the local or edge 110 by rendering and/or transmitting one or more portions of the XR data to be rendered by at least one other server (e.g., at least one of the server(s) 120-128). The XR data 130 can be analyzed by the server(s) 118. Based on the XR data 130 being analyzed, the server(s) 118 can process at least one portion of the XR data 130 for rendering, and/or transmit at least one portion of the XR data 130 to the server(s) 120-128 for rendering.

In various examples, the XR data 130 can include the XR data having the first priority being rendered by the local or edge 110 (e.g., the sever(s) 118). The XR data having the first priority can be rendered by the local or edge 110 based on the local or edge 110 being nearer to the user device 102 than other portions of the network(s).

By utilizing the server(s) 118 to manage the XR data 130 at the local or edge 110, the priorities of the portion(s) of the XR data 130 can be identified and utilized to identify network location(s) (e.g., the local or edge 110, the near-edge 112, the mid-edge 114, the far-edge 116, etc., or any combination thereof) to render the portion(s), respectively, of the XR data 130. The portion(s) of the XR data 130 having respectively higher priority (ies) can be rendered closer to the user device(s) 102, in comparison to the portion(s) of the XR data 130 having respectively lower priority (ies).

As a hypothetical example, a portion of the XR data 130 many include data associated with items being presented by a user device 102, the items including an item (e.g., an item representing a user) and another item (e.g., another item representing another user). Rendering for either or both of the items may be performed at different locations of the network than for other items (e.g., a slow moving animal in the distance) that do not require as many resources to perform rendering. The rendering for either or both of the items may be performed close to the user device 102 to ensure that presentation by the user device 102 of the items is smooth and “natural.”

In the hypothetical example, the rendering for either or both of the items (e.g., the items representing the users) may be performed at a location with respect to the user device 102 that is capable of satisfying threshold requirements. In some examples, the rendering for either or both of the items (e.g., the items representing the users) may be performed at the local or edge 110 based on the local or edge 110 being capable of maintaining one or more metrics (e.g., a delay, a latency, etc.) associated with rendered XR data below one or more corresponding thresholds (e.g., a delay threshold, a latency threshold, etc., respectively). In those or other examples, the rendering for either or both of the items (e.g., the items representing the users) may be performed at the local or edge 110 based on the local or edge 110 being capable of maintaining one or more metrics (e.g., a refreshment rate, etc.) associated with rendered XR data above a corresponding threshold (e.g., a refreshment rate threshold, etc.).

In those or other examples, the XR data 132 and/or 134 can be rendered and transmitted from the server(s) 120 and/or 124 of the near-edge 112, respectively. In those or other examples, the XR data 136 and/or 138 can be rendered and transmitted from the server(s) 122 and/or 126 of the mid-edge 114, respectively. In those or other examples, the XR data 140 can be rendered and transmitted from the server(s) 128, of the far-edge 116.

In various examples, the XR data 132 can have a same priority as the XR data 134. Alternatively, the XR data 132 exchanged between the user device(s) 102 and the server(s) 120 can have a different priority than the XR data 134.

For instance, with examples in which the XR data 132 can has the same priority as the XR data 134, corresponding proportions of XR data that includes the XR data 132 and the XR data 134 can be identified (e.g., selected, managed, etc.) based on one or more resource levels (e.g., compute, network, and/or memory resource levels) associated with the server(s) 120 and/or one or more resource levels (e.g., compute, network, and/or memory resource levels) associated with the server(s) 124. The proportions can be identified to allocate the data without utilizing respective priorities of the data 132 and/or the data 134.

For instance, with examples in which the XR data 132 can has the different priority as the XR data 134, corresponding proportions of XR data that includes the XR data 132 and the XR data 134 can be identified based on a sub-priority (e.g., a relatively higher sub-priority within the second priority, utilized for identifying a rendering network location) of the XR data 132 and a sub-priority (e.g., a relatively lesser sub-priority within the second priority, utilized for identifying a rendering network location) of XR data 134.

Alternatively or additionally, the proportions of XR data that includes the XR data 132 and the XR data 134 can be identified based on one or more resource levels (e.g., compute, network, and/or memory resource levels) associated with the server(s) 120 and/or one or more resource levels (e.g., compute, network, and/or memory resource levels) associated with the server(s) 124. The proportions can be identified to allocate the data utilizing respective priorities (e.g., the respective sub-priorities) of the data 132 and/or the data 134, to allocate whichever of the data 132 and/or data 134 has a relatively higher sub-priority to the server(s) 120 and/or the server(s) 124 with the relatively greater levels of available resources.

In various examples, any data (e.g., the XR data 136) can have a same priority and/or a different priority as any other data (e.g., the XR data 138). Alternatively, the XR data 136 exchanged between the user device(s) 102 and the server(s) 120 can have a different priority than the XR data 138. In some examples, corresponding proportions of XR data that includes the XR data 136 and/or 138 can be identified (e.g., selected, managed, etc.) in a similar way as discussed above for the XR data 132 and/or 134.

In some implementations, any of the computer-altered reality data (e.g., initial computer-altered reality data) can be rendered, based on the server(s) 118 rendering at least one portion (or “at least one segment”) of the initial computer-altered reality data, and/or based on the server(s) 118 receiving at least one portion (or “at least one segment”) of the initial computer-altered reality data being rendered by at least one of the server(s) 120-140.

The server(s) 118 can transmit any of the rendered computer-altered reality data (e.g., rendered XR data) to the user device(s) 102. In some examples, the server(s) 118 can receive rendered computer-altered reality data of the second priority from the server(s) 120 and/or 124. In those or other examples, the server(s) 118 can receive rendered computer-altered reality data of the third priority from the server(s) 122 and/or 126. In those or other examples, the server(s) 118 can receive rendered computer-altered reality data of the fourth priority from the server(s) 140. In various examples, any of the servers (e.g., any of the sever(s) 118-128) can relay and/or route data from, and/or to, any of the servers (e.g., any of the sever(s) 118-128).

The locations (e.g., one or more rendering locations) of the network(s) utilized for rendering any portion (e.g., a partial portion of an entire portion) of the XR data 130 can be identified based on the priority (ies). In some examples, the rendering location(s) can be identified based on the category (ies) of the item(s) (e.g., object(s)). For instance, an item may be assigned, as an item (e.g., a “category #1 item”) of a first category (e.g., a “category #1”) (e.g., a category including items associated with “highly interactivity” and “fast motion,” such as for an item with which data of the first highest priority is associated) to the local or edge (e.g., a low-latency local or edge) 110.

In such an instance or in another instance, at least one item can include an item (e.g., a “category #2 item) of a second category (e.g., a “category #2”) (e.g., a category including items associated with “interactivity” being at a relatively lower level, and with “auto-motion” (e.g., motion including various types of motion, such as automated motion, which can include, in some cases, motion involving items moving based on “physics,” such as any number of items/objects colliding and/or bumping into, and/or interacting with, any number of other items/objects, etc.) being at a relatively lower level, such as for an item with which data of the second highest priority is associated), and/or an item (e.g., a “category #3 item) of a third category (e.g., a “category #3”) (e.g., a category including items associated with “interactivity,” and “slow motion,” being at a relatively lower level and/or a different level than “auto-motion,” such as for an item with which data of the third highest priority is associated). In some examples, the “category #2 item can be assigned to the near-edge 112. In some examples, the “category #3 item can be assigned to the mid-edge 114.

In such an instance or in another instance, the at least one item that includes the “category #2 item” and/or the “category #3 item” can include an item (e.g., a “category #4 item) of a fourth category (e.g., a “category #4”). For example, the fourth category, which can include items associated with “slow motion near the view point,” such as for an item with which data of the third highest priority is associated, can be assigned to the mid-edge 112. In some examples, the “category #3 item and/or the “category #4” item can be assigned to the mid-edge 114.

In such an instance or in another instance, an item (e.g., a “category #5 item) of a “category #5” (e.g., a category including items that are “stationary,” with no motion, or items that have “slow motion but farther away,” such as for an item with which data of the fourth highest priority is associated), can be assigned to the far-edge 116. However, any other assignments can be utilized for rendering various types of items of various categories and/or priorities.

In various examples, the rendered computer-altered reality data of different priorities can be stored and/or received by the server(s) 118 and from the respective server(s) 120-140 at different times. The rendered computer-altered reality data of the first priority, for example, can be stored prior to the rendered computer-altered reality data being received from the respective server(s) 120-140. The rendered computer-altered reality data of the first priority, for example, can be completed and stored earlier, based on a time of completion of the rendering of the computer-altered reality data of the first priority being prior to a time of receival of the rendered computer-altered reality data of the second-fourth priorities being received from the respective server(s) 120-140.

In some examples, OTA RTTs and/or rendering rates of the computer-altered reality data can be identified by the server(s) 118. In those or other examples, corresponding OTA RTTs and/or corresponding rendering rates can be selected by the server(s) 118 to be higher for the relatively higher priority computer-altered reality data than for the relatively lower priority computer-altered reality data. For example, an OTA RTT (and/or a rendering rate) for the computer-altered reality data of the first priority can be lower than an OTA RTT (and/or a rendering rate), respectively, for the computer-altered reality data 132 and/or 134.

In some instances, the server(s) 118 can transmit one or more OTA RTT signals and/or one or more rendering rate signals to the at least one of server(s) 120-140, the rendering rate signal(s) including rendering rate(s) to be used by the server(s) 120-140 for rendering the computer-altered reality data 132-140, respectively. For instance, an OTA RTT (e.g., an OTA RTT threshold) and/or a rendering rate for the computer-altered reality data of the first priority can be less than 20 milliseconds (ms), and/or higher than 60 frames per second (fps), respectively, based on the computer-altered reality data of the first priority including data with a relatively greater level of interactivity and a relatively greater level of motion.

For instance, an OTA RTT (e.g., an OTA RTT threshold) and/or a rendering rate for the computer-altered reality data 132 and/or 134 of the second priority can be lower than 60 ms and/or higher than 30 frames per second (fps), respectively, based on the computer-altered reality data of the second priority including data with a relatively greater level of interactivity and a relatively lower level of motion. For instance, an OTA RTT (e.g., an OTA RTT threshold) and/or rendering rate for the computer-altered reality data 136 and/or 138 of the third priority can be lower than 100 ms and/or higher than 15 frames per second (fps), respectively, based on the computer-altered reality data of the third priority including data with a relatively lower level of interactivity and a relatively lower level of motion. For instance, an OTA RTT (e.g., an OTA RTT threshold) and/or rendering rate for the computer-altered reality data 140 of the fourth priority can be between 100-150 ms and/or between 5-10 frames per second (fps), respectively, based on the computer-altered reality data of the fourth priority including data associated with no interaction and with other less resource intensive types of motion (e.g., motion managed by various lower-resource demanding processes, such as decoupled rendering).

Although various OTA RTTs and/or various rendering rates may be utilized for various types of data for various priorities, as discussed above in the current disclosure, it is not limited thereto. In various examples, any OTA RTTs and/or any rendering rates associated with any types of data associated with any priorities may be utilized for rendering for purposes of implementing any techniques as discussed throughout the current disclosure.

Although priority information (e.g., one or more priorities) can be identified based on characteristic data, such as motion data (e.g., one or more levels of motion) and/or interactivity data (e.g., one or more levels of interactivity), as discussed above in the current disclosure, it is not limited as such. In some examples, the priority information can be identified (e.g., identified, determined, generated, selected, modified, etc.), based on the motion data, the interactivity data, the complexity data, the device data, one or more of other types of data, or any combination thereof.

In some examples, one or more priorities (e.g., one or more initial priorities) being initially identified can be based on the motion data, and, alternatively or additionally, the complexity data and/or the device data. In those or other examples, one or more priorities (e.g., one or more priorities being identified subsequently to the initial priority (ies) can be identified based on the motion data, the complexity data, the device data, and/or the interactivity data.

Although various types of data can include the interactivity data for purposes of identifying priority information, as discussed above in the current disclosure, it is not limited as such. In some examples, any of the priority information (e.g., the initial priority (ies) and/or one or more of any others of the priority (ics)) can be identified utilizing the interactivity data. In those or other examples, the interactivity data can be based on one or more of various types of actions associated with the item(s), the user device(s) 102, the user(s) of the user device(s), etc.

By decentralizing rendering, which can be performed on multiple resources, including the user device(s) 102 and various servers (e.g., the server(s) 118-128) at various locations throughout the network environment 100, rendering of the computer-altered reality data can be performed in a timely and effective manager. The timely and effective rendering can be performed notwithstanding at least one of the user device(s) 102 being located in areas where there are not enough local or edge compute resources to render all of the computer-altered reality data at a single location.

In various examples, any of the rendering performed via the network environment 100 can be decentralized (e.g., as decentralized, location based rendering, based on availability of resources) by controlling nearby servers to render data for highly interactive and/or highly mobile items and controlling servers that are farther away to render data for less interactive and/or less mobile items. While at least one server (e.g., at least one of the far-edge server(s) 128, or other servers, such as the mid-edge servers 122 or 126, or any other servers located at distances that are greater than distances of the local or edge server(s) 118 from the user device(s) 102) that is farther away would not work for content is highly interactive and/or highly mobile, the farther away servers can relieve the computational burden and/or the communication burden of the nearby servers. As a result, user experiences may be improved by optimizing overall rendering capabilities.

While location based rendering can be performed, as discussed throughout the current disclosure, it is not limited as such. The location based rendering can be performed, alternatively or additionally, along with one or more other techniques. In various examples, the location based rendering can be performed, alternatively or additionally, along with distributed computing. The distributed computing can include calculating and utilizing one or more delays associated with various resources (e.g., the user device(s) 102, the server(s) 118-140, and so on, or any combination thereof), respectively), and rendering the computer-altered reality data based on the delay(s).

The distributed computing can include, if some of the servers (e.g., any of the server(s) 118-140) are overly burdened, sending at least one job (e.g., at least one portion of the computer-altered reality data, and/or instructions to render the at least one portion of the computer-altered reality data) at least one other servers (e.g., any of the server(s) 118-140) to render the at least one job, and to then forward the rendered at least one portion of the computer-altered reality data to at least one of any of the user device(s) 102 that need it.

The distributed computing can include identifying a shortest route (e.g., a shortest network path) from any of the server(s) 118-140 that are overly burdened to one or more of any of the any of the server(s) 118-140 server(s) 118-140. The at least one job being pass to the other server(s) 118-140 can be performed based on the server(s) 118-140 being a shortest route away from the server(s) 118-140 that are overly burdened. The distributed computing can then include, if the server(s) 118-140 being the shortest route away from the server(s) 118-140 that are overly burdened, identifying any of the server(s) 118-140 that are next farthest away, and so on.

The distributed computing can include identifying various routes (e.g., network paths) between the server(s) 118-140 that are overly burdened and the server(s) 118-140 that are at different route lengths from the server(s) 118-140 that are overly burdened. The distributed computing can include identifying availability of resources of the various server(s) 118-140. Pricing differentiation can be utilized to identify at least one server pricing score, including a combination of the length of the route to, and availability of, any of the server(s) 118-140.

The server pricing score can be identified based on by balancing the length of the route (e.g., network path) to, and availability of, the server(s) 118-140. The balancing can be performed by identifying a weight of the length of the route to, and a weight of the availability of any of the server(s) 118-140. The length of the route to, and availability of, any of the server(s) 118-140 can be utilized along with the respective weights to calculate the server pricing scores. The jobs can be forwarded to any of the server(s) 118-140 with the greatest server pricing score.

In some examples, user profile information (e.g., the user profile(s), and/or information in, and/or including, the user profile(s)) associated with the users of the user device(s) 102 can be utilized for the location based rendering and/or the distributed computing. In those or other examples, any of the server(s) 118-140 can be utilized for jobs associated with the users based on levels of user classifications. Users paying for greater costs for higher levels of user classifications can receive higher quality job placement. In some examples, a job for a user paying for a higher level of user classification can be performed by a server associated with a higher server pricing score, and a job for a user paying for a lower level of user classification can be performed by a server associated with a lower server pricing score.

The local or edge server(s) 118 can utilize one or more beacons (or “heartbeat(s)”) being transmitted along with the computer-altered reality data being transmitted to the server(s) 120-140 to be rendered. The beacon(s), being transmitted in one or more signals, including the computer-altered reality data, and/or separate from the computer-altered reality data, can be utilized by the server(s) 120-140 for rendering the data. Alignment of timing of the rendered computer-altered reality data can be ensured by the server(s) 120-140, based on the beacon(s).

The local or edge server(s) 118 can blend the rendered computer-altered reality data. The local or edge server(s) 118 can be operated, as a primary node, for example, to blend all the rendered computer-altered reality data. The local or edge server(s) 118 being operated as the primary node can reduce the network congestion in comparison to existing technology. The local or edge server(s) 118 can ensure that all of the rendered computer-altered reality data to be utilized by the user device(s) 102 is synchronized (e.g., based on the beacon(s)).

In some examples, the primary node can utilize an item library (e.g., an object library) (or “library”) (e.g., an entire item and/or object library including all items and/or objects associated with an experience (e.g., a “world,” game, etc., or any combination thereof) associated with a user device 102. The library can be utilized by the primary node to manage the location(s) of the rendering, and/or any data utilized therefor.

The local or edge server(s) 118 can receive all of the rendered computer-altered reality data from the server(s) 120-140 and decide how to move forward. In some examples, the local or edge server(s) 118 can identify applicable portions of all of the rendered computer-altered reality data being received from the server(s) 120-140.

In some examples, the local or edge server(s) 118 can identify portions of the computer-altered reality data not needing to be rendered. In those or other examples, at a particular time, the local or edge server(s) 118 can identify (e.g., identify, determine, select, retrieve, receive, capture, etc.) portions of the computer-altered reality data (e.g., data for foreground objects) needing to be rendered, and portions of the computer-altered reality data (e.g., data for background objects) not needing to be rendered. The local or edge server(s) 118 can render any of the computer-altered reality data, and/or transmit any of the computer-altered reality data rendered by the server(s) 120-140.

The local or edge server(s) 118 can blend the computer-altered reality data (e.g., the foreground data) being rendered, and ignore other portions of the computer-altered reality data (e.g., the background data) not being rendered. The local or edge server(s) 118 can send the blended computer-altered reality data (e.g., the rendered data and, possibly, the data not needing to be rendered, if necessary, since the user device(s) 102 may reuse previous background data, which the local or edge server(s) 118 can utilize to determine to not send some of the data if it is not necessary to do so) to the user device(s) 102.

In some examples, the local or edge server(s) 118 can include information in the signals that include the blended computer-altered reality data to the user device(s) 102 about whether the user device(s) 102 are to reuse previous data. For example, the signals can include identifiers associated with previous data that the local or edge server(s) 118 identify as being reusable (e.g., background data not currently needed to be rendered). The identifiers associated with the previous data can be utilized by the user device(s) 102 to reuse the background data, for example, which can save network bandwidth. The user device(s) 102 can receive the blended computer-altered reality data, and the information (e.g., identifier(s)) for data to be reused, and generate one or more final compositions of the computer-altered reality data. In some examples, the final composition(s) of the computer-altered reality data can be presented by the user device(s) 102 to the user(s) of the user device(s) 102.

In various implementations, the local or edge server(s) 118 can be operated to manage the location based rendering, as coherent and coordinated rendering. In some examples, the local or edge server(s) 118, when starting to render the computer-altered reality data, can coordinate rendering utilizing two principles. As a first principle of the two principles, the local or edge server(s) 118 can coordinate rendering of the computer-altered reality data (e.g., one or more objects) that belongs to a same “experience.” The computer-altered reality data can perform the rendering, utilizing a time synchronization, such as a time synchronization based on the beacon(s), as discussed above. The local or edge server(s) 118 can ensure the object(s) are time aligned

As a hypothetical example, the local or edge server(s) 118 can ensure that two items (e.g., objects) interacting with each other (e.g., fighting each other) are time aligned. If a user of a user device 102 controls one object (e.g., an object representing a user), the object can be time aligned by the local or edge server(s) 118 to be time synced with the other object. For example, the local or edge server(s) 118 can ensure that the objects in the same experience are rendered in a same timeframe with one another. All objects in the experience are rendered in the same timeframe to enable coherency via the time synchronization. Alternatively or additionally, rendering of the objects is coordinated by the local or edge server(s) 118 to ensure the objects are in the same “spatial frame,” as well as in the same time frame.

As a hypothetical example, software applications and/or software programs (e.g., video games) utilizing computer-altered reality data can be developed to utilize the location based rendering, as discussed above. A video game can include a plug-in (e.g., a service plug-in) (e.g., a library call) (e.g., a function call) to utilize the location base rendering. The local or edge server(s) 118 can process computer-altered reality data associated with the video game based on the plug-in being identified. The local or edge server(s) 118 can utilize various other servers (e.g., the server(s) 120-140) based on priorities of the computer-altered reality data associated with the video game.

In the hypothetical example, an object being generated within the program (e.g., the video game) can be identified by the video game, as well as any information utilized by the local or edge server(s) 118 to render data associated with the object. Data (e.g., object related data) associated with the object can be generated and provided in data associated with the video game. The object related data can include color maps, texture maps, etc., to be utilized for rendering by the local or edge server(s) 118.

In the hypothetical example, the program data (e.g., the video game data) can also include an identifier indicating a data category associate with the object. The data category identified by the video game can be selected from among one or more categories identified (e.g., identified, provided, selected, generated, etc.) by a service provider (e.g., a service provider that managing the service provider network 104). The data category (ies) can include one or more of the data category (ies) (e.g., 5 categories, 7 categories, etc.) (e.g., priority (ies)), as discussed above. The video game developer can identify (e.g., select), and include in the video game data, corresponding categories associated with objects of the video game, based on the data category (ies) (e.g., the data category (ies) provided by the service provider).

In the hypothetical example, the local or edge server(s) 118 can identify (e.g., identify, determine, select, modify, update, etc.) the appropriate server for rendering the object based on the category of the object and/or any other categories (e.g., updated and/or modified categories, which may be identified/changed dynamically, such as by the user device 102 and/or one or more of any other servers being utilized for execution of the program) of the object. Dynamic updates can be performed based on one or more any types of updates of the characteristic data, such as updates received from the user device 102 and/or the other server(s). The object, if part of the background, or being an object with which the user is not interacting with frequently, can be rendered by a farther off server. Or, the object, if part of the foreground, or if being an object with which the user is interacting with frequently, can be rendered by a nearby server.

In the hypothetical example, category (ies) of the object(s) can overlap for various object characteristics. An object, if moving fast, and if being an object with which a user is not interacting, may be classified similarly as another object, if not moving fast, and if being an object with which a user is frequently interacting.

In the hypothetical example, data (e.g., update data, such as updated characteristic data based on, and/or indicating, the update(s)) (e.g., updated characteristic data based on an object “going to sleep” or “waking up”) received from the user device(s) 102 and/or one or more servers (e.g., the local or edge server(s) 118, one or more other servers, or any combination thereof) can be utilized to modify a category associated with the object dynamically (e.g., in real-time, or in pseudo real-time), based on behavior of the object changes. The object being an animal at sleep, might belong to a lower category. The animal, waking up, might be moved to higher category based on motion of the animal increasing. The category being changed can happen as a result of the change of motion, while the video game is operating, dynamically, in real-time. (e.g., the category change can be performed based on a category modification flag being set, in response to the animal waking up).

In some examples, the priority (ies) and/or the rendering location(s) can be modified based on the update data. The priority (ies) and/or the rendering location(s) can be set and/or adjusted preemptively based on predicted data associated with possible/future update data and/or with possible/future updates.

In the hypothetical example, the modification of the category can be performed by the user device(s) 102 and/or one or more servers (e.g., the local or edge server(s) 118, one or more other servers, or any combination thereof) based on the user device(s) 102 and/or the server(s) detecting one or more game logic operating levels (or “usage level(s)”), and/or based on changes associated with any of the game logic, any of the operating levels, any of the computer-altered reality data, etc., or any combination thereof. The operating level(s) changing, based on the animal waking up and operation of the graphic processing units (GPUs) increasing, may be a result of rendering requirements increasing due to increased motion of the object. The category can change and the local or edge server(s) 118 can maintain the server rending the object, or move the object to another server, for example, another server that is closer to the user device 102. Vice versa, the animal falling asleep can be demoted to a lower category and moved to a server farther away from the user device 102 based on the GPU operation decreasing (e.g., based on the GPU operation decreasing to 0%).

In the hypothetical example, the local or edge server(s) 118 can exchange communications with a back-end service orchestrator to identify GPU operating levels and/or to modify categories. The user device(s) 102 and/or one or more servers (e.g., the local or edge server(s) 118, the back-end service orchestrator, and/or one or more other servers) can be utilized to dynamically control the categories, which may be utilized to perform rendering server relocation due to category changes in real-time or pseudo real-time.

In the hypothetical example, the video game, upon completion of development, can include, and/or be utilized along with, metadata. The metadata, which can be generated along with the video game. can include the category (ies) associated with the object(s). The metadata can be transmitted by a server storing the metadata to a data center (e.g., a central data center) (e.g., a data center managed by one or more of the server(s) 118-140 and/or one or more other servers) utilized to manage the server(s) 118-140. In some examples, the video game data (e.g., the data associated with the video game), can be transmitted to the same central data center utilized to store the metadata. Alternatively or additionally, the video game data can be transmitted to, and stored, by different servers than the metadata.

In the hypothetical example, the local or edge server(s) 118 can utilize the video game data and/or the metadata for rendering the computer-altered reality data associated with the video game. The rendering based on the metadata can be performed according to the location based rendering, as discussed above, for purposes of implementing any of the techniques discussed herein.

In the hypothetical example, the video game can be identified based on the video game being distributed via passive game distribution. One or more operators (e.g., one or more developers) providing the video game can transmit, via one or more operator devices, the video game, for example, to the data center. The operator device(s) can perform pre-filtering to identify the category (ies) of the object(s), transmit the video game and/or the metadata to a central data center, and/or a data storage device closer to the edge servers, which can store the video game data and the metadata. The central data center, and/or a data storage device can be utilized by the local or edge server(s) 118 to control the video game data to be rendered, based on execution of the video game.

Alternatively or additionally, in the hypothetical example, the operator device(s) can push video game data and/or the metadata to the data center, such as without at least a portion of the pre-filtering. The central data center, and/or a data storage device can be utilized by the local or edge server(s) 118 to identify the category (ies) associated with the object(s) and/or to render the video game data based on execution of the video game.

Alternatively or additionally, in the hypothetical example, the video game data can be distributed via active game distribution. The operator device(s) can distribute all object binaries (e.g., one or more binaries utilized to render the object(s), the binary (ies) being included in, and/or separate from, the metadata) to different locations based on criteria (e.g., based on category (ies) of the object(s). The edge server(s) 118 can control rendering, blending, etc., of the video game data in a similar way as discussed above, based on rendering being performed by the server(s) utilizing the object binary (ies).

By coordinating rendering of objects associated with a similar experience in a same spatial frame relative to other objects, for ensuring spatial frame coordination (e.g., a relative position, a relative depth, etc., of all the objects), based on characteristics (e.g., item characteristics) (e.g., object characteristics) (e.g., motion, interactivity, etc.), other characteristics can be coordinated to ensure a viewing experience for the user is “natural.” In some examples, proper lighting can be managed (e.g., coordinated lighting can be utilized to ensure that the same light source(s) is (are) used (e.g., the sun for outdoors, a lamp for indoors, etc.)) for the item(s) (e.g., all of the item(s) with which the computer-altered reality data is associated). Spatial coordination can be utilized to control light coordination, depth coordination, location coordination, etc.

By utilizing location based rendering, the one or more beacons can be utilized to maintain a “cadence” (e.g., 20 times/second, 50 times/second, 100 times/second, etc.) for rendering the computer-altered reality data. The rendering can be performed at regular intervals to ensure that a rendering pipeline (e.g., a queue of data to be rendered) remains uncongested. The location based rendering can ensure that the server(s) 118-140 are able to maintain the rendering in a timely manner according to the cadence.

By maintaining the rendering in the timely manner, motion (e.g., hand gestures) associated with objects, for example, may be coordinated and/or managed so that a user viewing the hand gesture of an object in the computer-altered reality data, perceives it in real time as corresponding to an actual location and/or an actual motion of the user. Instead of relying on other processes (e.g., time warping) due to rendering time being too slow, which may otherwise occur in existing systems that do not use location based rendering, the server(s) 118-140 utilizing the techniques discussed herein are able to perform rendering of the object at speeds that are sufficient, and/or more than sufficient, for avoiding any types of delays. The location based rendering prevent awkward and/or unrealistic motion of objects by performing rendering at speeds adequate for presentation of smooth motion of the objects.

While the location based rendering can be based on locations of servers, as discussed above in the current disclosure, it is not limited as such. In some examples, the local or edge server(s) 118 can identify processing units of the user device(s) 102 and/or one or more GPUs of at least one server (at least one of the server(s) 118-140). The local or edge server(s) 118 can utilize the processing units of the user device(s) 102 and/or the GPUs of the server(s) for rendering. The processing units of the user device(s) 102 and/or the GPUs of the server(s) 118-140 can be identified for rendering the computer-altered reality data in a similar way as the server(s) 118-140 and utilized to implement any of the techniques as discussed herein.

While the local or edge server(s) 118 can include separate servers, as discussed above in the current disclosure, it is not limited as such. In some examples, the local or edge server(s) 118 can be incorporated into a single system, and/or can operate as a single system. In some examples, any of the server(s) (e.g., any of the server(s) 118-128) can be incorporated into a single system or a combination of systems, and/or can operate as a single system or a combination of systems.

While the term “server(s)” is utilized, for convenience and simplicity of explanation, throughout the current disclosure, it is not limited as such. In some examples, at least one computing device of any type may be utilized, alternatively or additionally, to at least one of the server(s) for purposes of implementing any of the techniques discussed herein.

While the term “computer-altered reality data” is utilized, for convenience and simplicity of explanation, throughout the current disclosure, it is not limited as such. In some examples, the computer-altered reality data can include the XR data for purposes of implementing any of the techniques discussed herein. Because XR rendering requirements for XR data may be relatively greater than for other types of data of other technologies, due to resource demands required for rendering XR data, the techniques of the current disclosure may be utilized to improve rendering capabilities in comparison to conventional techniques that do not use location-based rendering management based on activity data.

Although the network location(s) can be utilized for rendering the computer-altered reality data based on the distance(s) between the network location(s) and the user device location(s) as discussed above in the current disclosure, it is not limited as such. In some examples, identifying the network location(s) can be performed based on one or more server grades and/or one or more resource availabilities associated with the one or more server(s) 118-128, additionally or alternatively, to utilizing the distance(s) (e.g., one or more network location-device distances, one or more server-device distances, etc.) between the network location(s) and the user device location(s).

In a hypothetical example, the rendering can be performed for a data item of a first-highest priority at the local or edge 110 based on the server(s) of the local or edge 110 being near to the user device 102 than the server(s) at the other network locations. At least one server of the local or edge server(s) can be utilized to render the data item of the first-highest priority based on the at least one server having at least one relatively higher server grade and/or least one relatively greater resource availability than at least remaining server of the local or edge server(s).

In the hypothetical example, the rendering of the data item of the first-highest priority may be performed at the near-edge 112 (e.g., by at least one server of the near-edge 112), and/or any of one or more other locations of the network(s) (e.g., by at least one server at any of the other location(s)), instead of at the local or edge 110, based on the at least one other server at the near-edge 112 and/or the other network location, having a higher server grade and/or a relatively greater resource availability than the server(s) at the local or edge 110. The server grade(s) and/or the resource availability (ies) can be utilized, alternatively or additionally, to the server-device distances, and/or the network location-device distances, to identify rendering locations.

One or more weights can be assigned to information (e.g., server-device distance information including the server-device distance(s), network location-device distance information including the network location-device distance(s), server grade information including the server grade(s), resource availability information including the resource availability (ies), etc.) and utilized to determine the rendering location(s). For example, relatively greater weights can be assigned to, and/or utilized for, the distance(s) (e.g., the server-device distance(s), the network location-device distance(s)) than for weights assigned to, and/or utilized for, the server grade(s) and/or the resource availability (ies).

By assigning the weight(s), the distance(s) (e.g., the server-device distance(s), the network location-device distance(s)) can be prioritized above the server grade(s) and/or the resource availability (ies) for determining the rendering location(s). For example, the server grade(s) and/or the resource availability (ies) can be utilized as “tie-breakers” for cases in which the distance(s) are equal or relatively similar, such as for cases in which a difference between the distances is less than a threshold distance.

In some examples, the item classification(s) can be utilized to select the rendering location(s) based on the network and/or server location(s) (e.g., the distance(s)) and/or the server grade(s) (e.g., compute power of the server(s). In those or other examples, the item classification(s) can be dynamically changed, in real time, or pseudo real time, such as by software (e.g., game logic) being executed by the user device(s) 102 and/or one or more servers, depending on various state changes. For example, a position of an item (e.g., an object) relative to a camera view, physics of the item (e.g., the object) resulting in velocity changes, etc., or any combination thereof, can be utilized to identify and/or modify the item classification(s). The network location(s) utilized to render the items can be changed dynamically, in real time, or pseudo real time, based on the dynamic item classification identifications and/or modifications. Dynamic identification of the classification(s) and/or the dynamic modifications to network location(s) can be utilized to stop, start, transmit, receive, restart, temporarily pause, etc., at least a portion of the rendering of the items at one or more locations and/or to stop, start, transmit, receive, restart, temporarily pause, etc., at least a portion of the rendering (e.g., remaining portions of rendering to be completed) of the items at one or more other location(s).

Although the term “priority (ies)” can be utilized interchangeably with the term “category (ies),” “classification(s),” etc., for simplicity and convenience, as discussed above in the current disclosure, it is not limited as such. In some examples, any of the priority (ies) (e.g., at least one priority) can be utilized to determine any of the categories and/or any of the classifications (e.g., at least one category and/or at least one classification, respectively), or vice versa, for purposes of implementing any of the techniques discussed herein.

Although individual ones of the set(s) of the computer-altered reality data can be associated with a corresponding individual item, and individual ones the portion(s) of the computer-altered reality data can include at least one of the set(s) of the computer-altered reality data as discussed above in the current disclosure, it is not limited as such. In some example, individual ones of the set(s) of the computer-altered reality data can be associated with any number of the item(s), and/or vice versa. In those or other examples, individual ones of the portion(s) of the computer-altered reality data can be associated with any number of the set(s) (e.g., any number of the item(s)), and/or vice versa.

Although individual ones of set(s) of computer-altered reality data rendering information can be associated with rendering for a corresponding individual item, and individual ones of portion(s) of the computer-altered reality data rendering information can include at least one of the set(s) of the computer-altered reality data rendering information as discussed above in the current disclosure, it is not limited as such. In some example, individual ones of the set(s) of the computer-altered reality data rendering information can be associated with rendering for any number of the item(s), and/or vice versa. In those or other examples, individual ones of the portion(s) of the computer-altered reality data rendering information can be associated with any number of the set(s) (e.g., any number of the item(s)), and/or vice versa.

Although the terms “item” and “object” are utilized for simplicity and ease of discussion throughout the current disclosure, it is not limited as such. In some examples, the term “item” can refer to any of one or more aspects (e.g., one or more items, one or more objects, one or more portions, one or more features, one or more areas, one or more formations, one or more patterns, one or more forms, one or more shapes, and/or any of one or more other types of aspects) being represented by the computer-altered reality data. In those or other examples, the term “object” can refer to any of one or more items represented by the computer-altered reality data, the item to which any occurrence of the term “object” is referring including an item that is self-contained, enclosed, independent, automated, mobile, stationary, and so on, or any combination thereof. For example, the term “object” can refer to a vehicle, a person, an animal, a building, a tree, etc.

In those or other examples, the item to which any occurrences of the term “item” is referring, such as with instances in which the term “item” is not referring to an item that is an object, can include any item (e.g., any non-object) that is expansive, globular, not self-contained, diffused, spread out, discontinuous, and so on, or any combination thereof. For example, the term “item,” in reference to any item that is not an “object,” can refer to one or more of various types of items, such as weather constructs (e.g., rain, fog, clouds, etc.), environmental constructs (e.g., landscapes, horizons, hills, etc.), atmospheric occurrences (e.g., northern lights, bioluminescent algae, etc.), and so on, or any combination thereof.

However, any techniques in which any occurrences of the terms “item” and/or “object” appear are not limited thereto, and any techniques being discussed with reference to the term “item” and/or the term “object” can be interpreted as being implemented, in some cases, in a similar way using one or more items of any type (e.g., one or more objects, one or more non-objects, or any combination thereof). In some implementations, the term “item” and object” may be interpreted as being interchangeably referring to any representation associated with the computer-altered reality data.

Although the term “object” refers to any of the object(s) of various types, for simplicity and ease of explanation, as discussed throughout the current disclosure, it is not limited as such. In some examples, the term “object” can refer to any of one or more objects of one or more types (e.g., vehicles, persons, animals, etc.), such as an object in motion. In those or other examples, the term “object” can refer to any of one or more objects of one or more other types (e.g., buildings, rocks, trees (e.g., stationary trees), etc.), such as an object (e.g., a stationary object) not in motion.

In those or other examples, the term “object” can refer to any of one or more objects of one or more types, such as an object with which the user is interacting highly, or interacting in any other way (e.g., with moderate interactivity). In those or other examples, the term “object” can refer to any of one or more objects of one or more other types, such as an object with which the user is not interacting.

Although the term “user” can be utilized for various purposes, for purposes of convenience and explanation, as discussed above in the current disclosure, it is not limited as such. Any occurrences of the term “user” can be utilized to refer to any item and/or computer-altered reality data portion and/or set, etc., with respect to any function and/or element (e.g., user interactivity can be utilized to refer to interactivity represented by sets of computer-altered reality data associated with items representing the users, etc.).

Although the set(s) of the computer-altered reality data can be rendered based on the priority (ies) as discussed above in the current disclosure, it is not limited as such. In some examples, one or more subsets of any of the set(s) can be rendered based on one or more priority (ies) (e.g., one or more of the priority (ies), one or more sub-priorities of the priority (ies), etc.), in a similar way as for the computer-altered reality data set(s), as discussed above. For example, any of the subset(s) can be associated with portions of any of the item(s), such as a portion that includes color, lighting, one or more polygons, etc., associated with an item. The subset(s) can be rendered utilizing decoupled rendering at the rendering locations based on the priority (ies) and/or the sub-priority (ies).

Although any of the service provider network 104, the service provider cloud network 106, and/or the external network 108, can include one or more 5G networks, as discussed in the current disclosure, it is not limited as such. In some examples, the service provider network 104, the service provider cloud network 106, and/or the external network 108, at least one of other types of networks, or any combination thereof, can include one or more overlay networks, in any combination, such as separate from, connected to, and/or integrated with, the 5G network(s).

In some examples, the server(s) 118 can be utilized as a “touch point” between any of the overlay networks and/or any of the cloud networks. In those or other examples, the server(s) 118 can be utilized to inject data (e.g., any data associated with the rendering) into a 5G radio access network (RAN) associated with any of the 5G network(s) (e.g., the service provider network 104). For instance, with examples in which data is injected via the server(s) 118 into the 5G RAN, the service provider network 104, which can be included as the 5G RAN, can receive the data from the server(s) 118; and the server(s) 118 can be included as a “point” where an overlay network (e.g., the service provider cloud network 106, the external network 108, or any combination thereof) has connectivity with, and/or access to, the 5G network via the local or edge 110 and/or the server(s) 118 (e.g., the local or edge 110 and/or the server(s) 118 can provide connectivity with, and/or access to, the 5G network, for the overlay network(s), which can be included as the service provider cloud network 106, the external network 108, or any combination thereof).

Although individual ones of the various level(s) of interactivity and/or individual ones of the various level(s) of motion can be indicated in, and/or utilized to identify various portions of the rendering information and/or the rendering location information, as discussed above in the current disclosure, it is not limited as such. In some examples, individual ones of the level(s) of activity can include a level associated with rapidity, frequency, magnitude, etc. or any combination thereof, of activity (e.g., interactivity) between the item and at least one other item (e.g., any other portion of the experience). In those or other examples, individual ones of the level(s) of motion can include a level associated with rapidity, frequency, magnitude, etc., or any combination thereof, of motion.

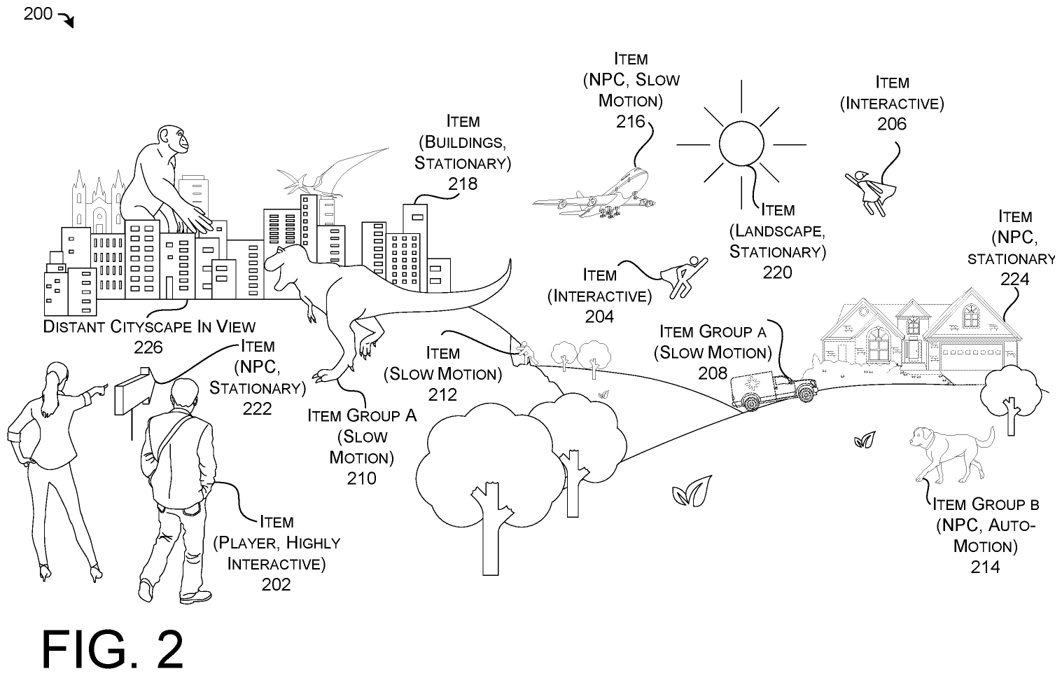

FIG. 2 depicts an example presentation 200 of computer-altered reality data being managed by location-based computer-altered reality data rendering management using rendering oriented characteristic data. The presentation 200 can include one or more items in the computer-altered reality data (e.g., the extended reality (XR) data 130), as discussed above with reference to FIG. 1.

In various examples, the XR data 200 can include one or more items (e.g., one or more objects). The item(s) can include at least one item associated with at least one user, the at least one item including at least one of an item 202, an item 204, or an item 206. In those or other examples, the item 202 can be associated with an object (e.g., a user) (or “player”), for example, with the item 202 (e.g., a representation of a person and/or a portion of a person), associated with a user of a user device, such as a user device 102, as discussed above with reference to FIG. 1). Individual ones of the item 204 and/or the item 206 can be associated with an object (e.g., a “protagonist”).

In some examples, the item 202 can have one or more characteristics (or “item characteristic(s)”) (e.g., object characteristics), including a view characteristic (e.g., a “first-person view”), an interactivity characteristic (e.g., an interactivity of “highly “interactive”), a motion characteristic (e.g., a motion of “fast motion”). In those or other examples, individual ones of the item 204, and/or the item 206 can have one or more characteristics (or “item characteristic(s)”) (e.g., object characteristics), including a view characteristic (e.g., a “third-person view”), an interactivity characteristic (e.g., an interactivity of “interactive”), a motion characteristic (e.g., a motion of “auto-motion,” near the viewpoint).

In various examples, the item(s) can include at least one item (e.g., at least one object) in a group (or “Group A”), the at least one item including at least one of an item 208 or an item 210. In those or other examples, the item 208 can be associated with one or more objects (e.g., a vehicle) (e.g., an ambulance), and the item 210 can be associated with one or more objects (e.g., an animal) (e.g., one or more dinosaurs, one or more “king-kong” animals). In those or other examples, individual ones of the item 208 and/or the item 210 can have one or more characteristics (or “item characteristic(s)”), including an interactivity characteristic (e.g., an interactivity of “interactive”) and a motion characteristic (e.g., a motion of “slow” motion, far away from the view point). Individual ones of the item 208 and/or the item 210 can be associated with an object (e.g., a “protagonist”).

In various examples, the item(s) can include at least one item (e.g., at least one object), the at least one item including an item 212. In those or other examples, the item 212 can be associated with one or more objects. In those or other examples, the item 212 can have one or more characteristics (or “item characteristic(s)”), including an NPC (e.g., a bot) characteristic and a motion characteristic (e.g., a motion of “auto-motion,” near the view point).

In various examples, the item(s) can include at least one item (e.g., at least one object) in a group (or “Group B”), the at least one item including an item 214. In those or other examples, the item 214 can be associated with one or more objects (e.g., an animal) (e.g., a dog). In those or other examples, the item 214 can have one or more characteristics (or “item characteristic(s)”), including an NPC (e.g., a bot) characteristic and/or a motion characteristic (e.g., a motion of “auto-motion, near the view point).

In various examples, the item(s) can include at least one item (e.g., at least one object), the at least one item including an item 216. In those or other examples, the item 216 can be associated with one or more objects (e.g., a vehicle) (e.g., a plane). In those or other examples, the item 216 can have one or more characteristics (or “item characteristic(s)”), including an NPC (e.g., a bot) characteristic and/or a motion characteristic (e.g., a motion of “slow” motion, farther away from the view point).

In various examples, the item(s) can include at least one item, the at least one item including at least one of an item 218 or an item 220. In those or other examples, the item 218 can be associated with one or more buildings, and the item 220 can be associated with one or more landscape portions (e.g., a sun). In those or other examples, individual ones of the item 218 and/or the item 220 can have one or more characteristics (or “item characteristic(s)”), including a building and/or landscape characteristic, and/or a motion characteristic (e.g., a stationary characteristic).

In various examples, the item(s) can include at least one item, the at least one item including at least one of an item 222 or an item 224. In those or other examples, the item 222 can be associated with one or more signs, and the item 224 can be associated with one or more buildings (e.g., a house). In those or other examples, individual ones of the item 222 and/or the item 224 can have one or more characteristics (or “item characteristic(s)”), including an NPC (e.g., a bot) characteristic and/or a motion characteristic (e.g., a stationary characteristic.

In various examples, the item(s) can include at least one item, the at least one item including an item 226. In those or other examples, the item 226 can be associated with one or more distant cityscapes (e.g., a cityscape in a view of a user) (e.g., a cityscape in a “real world” view of an environment of a user).

In various implementations, the item(s) of the computer-altered reality data in the presentation 200 can be rendered based on one or more categories (e.g., the item category (ies), as discussed above with reference to FIG. 1). In some examples, the item 202 can be rendered according to the item category (ies), including the first category (e.g., “Category #1”). In those or other examples, at least one of the item 204 or the item 206 can be rendered according to the item category (ies), including the second category (e.g., “Category #2”). In those or other examples, at least one of the item 208 or the item 210 can be rendered according to the item category (ies), including the third category (e.g., “Category #3”). In those or other examples, at least one of the item 212 or the item 214 can be rendered according to the item category (ies), including the fourth category (e.g., “Category #4).

In those or other examples, at least one of the item 216, the item 218, the item 220, the item 222, or the item 224 can be rendered according to the item category (ies), including the fifth category (e.g., “Category #5”). In those or other examples, at least one of the item 226 may not be rendered due to the item 226 being a “real world” item.

By utilizing the category (ies), rendering of the item(s) 202-224 can be performed at different network location(s). In some examples, rendering of at least one of the items (e.g., the items 202-206) can be performed at locations closer to the user device 102, in comparison to other items. In those or other examples, rendering of at least one of the items (e.g., the items 222 and 224) can be performed at locations farther away from the user device 102. In those or other examples, rendering of other items (e.g., the items 208-220) can be performed at locations corresponding to priority (ies) of rendering of the item(s), as discussed above with reference to FIG. 1.

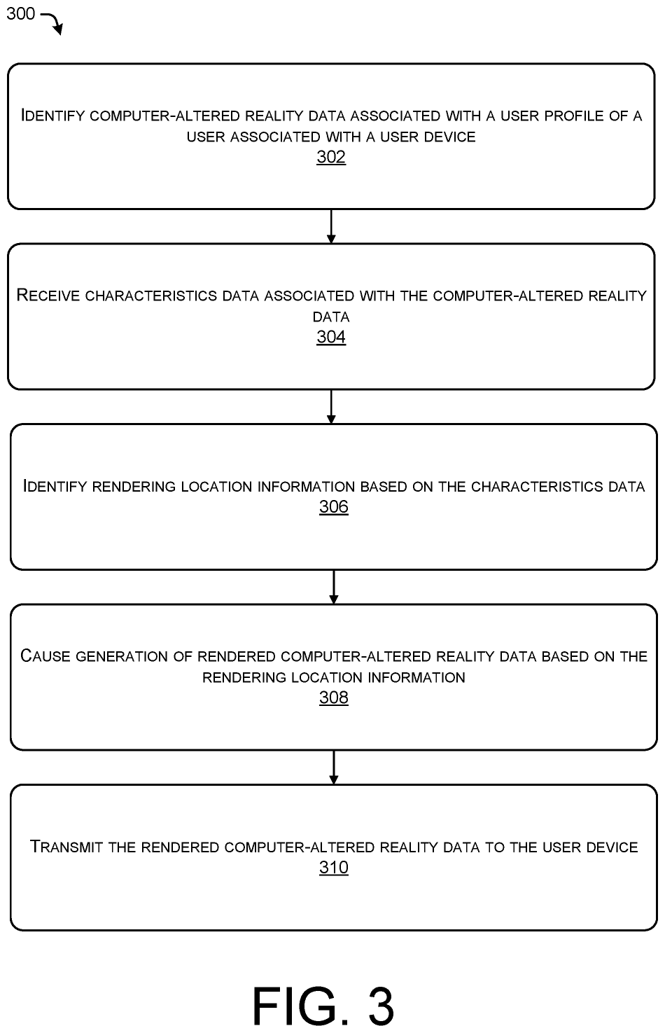

FIG. 3 depicts an example process for location-based computer-altered reality data rendering management using rendering oriented characteristic data illustrated in FIGS. 1 and 2.

At operation 302, the process can include identifying computer-altered reality data associated with a user profile of a user associated with a user device. For example, during a game development stage, distinct “objects” associated with computer-altered reality data models can be identified (e.g., identified, determined, generated, selected, modified, etc., via one or more game logics being executed by one or more devices and/or servers). Each of the distinct “objects” can be assigned (e.g., assigned via one or more game logics being executed by one or more devices and/or servers) with a data set (e.g., an object characteristic data set, including a set of one or more characteristics of characteristic data associated with the object). The computer-altered reality data, which can be utilized for operation of the user device 102, can be identified (e.g., received by the primary node) to be rendered at one or more different locations of the network(s) 100.

At operation 304, the process can include receiving characteristic data associated with the computer-altered reality data. For example, during a service orchestration stage, characteristic data associated with the computer-altered reality data (e.g., a set of the computer-altered reality data associated with an item) can be identified (e.g., received by the primary node). The characteristic data can include, and/or be identified (e.g., received), based on data (or “user selection data”) associated with one or more user selections (e.g., one or more selections associated with the user of the user device 102), data (or “interactivity data”) associated with one or more interactions (e.g., one or more interactions of the item associated with at least one item and/or with the user of the user device 102), data (e.g., object characteristic data) associated with activity (e.g., item and/or user activity associated with one or more occurrences of activity, the activity being associated with the object and/or the user of the user device 102), data (or “computer generated item activity data”) associated with computer generated item activity (e.g., one or more occurrences of activity associated with one or more portions (e.g., one or more items) of computer generated data), and so on, or any combination thereof.

At operation 306, the process can include identifying rendering location information based on the characteristic data. In some examples, the rendering location information can include network category information (or “network classification information”) associated with the network location(s).

At operation 308, the process can include causing generation of rendered computer-altered reality data based on the rendering location information causing generation of rendered computer-altered reality data based on the rendering location information. By managing the network location(s) utilized for the computer-altered reality data rendering, an experience of the user operating the user device 102 may be improved.

At operation 310, the process can include transmitting the rendered computer-altered reality data to the user device 102. One or more edge servers 118 can transmit rendered computer-altered reality data (e.g., rendered XR data) to the user device) 102. In some examples, the server(s) 118 can receive rendered computer-altered reality data of the second priority from one or more servers (e.g., at least one of the server(s) 120-140), blend the received rendered computer-altered reality data, and transmit the blended rendered computer-altered reality data to the user device 102.

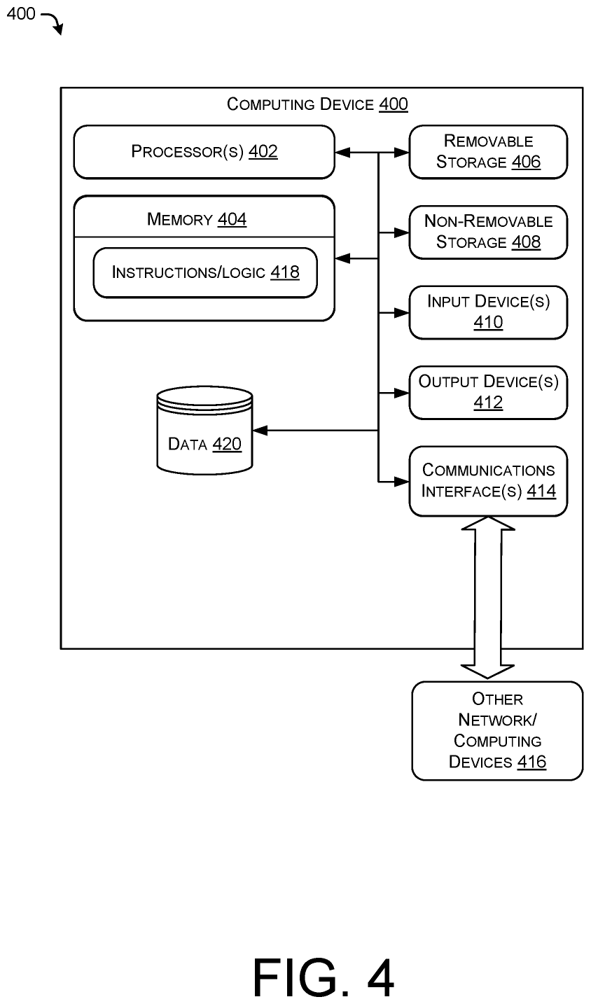

FIG. 4 depicts an example system architecture for a computing device 400. FIG. 4 is a block diagram of an example server computer utilized to implement the location-based computer-altered reality data rendering management using object characteristic data.

The computing device 400 may be representative of any of one or more devices (e.g., any of the user device(s) 102), any of one or more servers (e.g., any of the server(s) 118-140, as discussed above with reference to FIG. 1), as discussed above with reference to FIG. 1), or any combination thereof.

As shown, the computing device 400 may include one or more processors 402 and one or more forms of computer-readable memory 404. The computing device 400 may also include additional storage devices. Such additional storage may include removable storage 406 and/or non-removable storage 408.

The computing device 400 may further include input devices 410 (e.g., a touch screen, keypad, keyboard, mouse, pointer, microphone, etc.) and output devices 412 (e.g., a display, printer, speaker, etc.) communicatively coupled to the processor(s) 402 and the computer-readable memory 404. The computing device 400 may further include communications interface(s) 414 that allow the computing device 400 to communicate with other network and/or computing devices 416 (e.g., any of the user device(s) 102) (e.g., any of the server(s) 118-140) such as via a network. The communications interface(s) 414 may facilitate transmitting and receiving wired and/or wireless signals over any suitable communications/data technology, standard, or protocol, as described herein.

In various examples, the computer-readable memory 404 comprises non-transitory computer-readable memory 404 that generally includes both volatile memory and non-volatile memory (e.g., random access memory (RAM), read-only memory (ROM), erasable programmable read-only memory (EEPROM), Flash Memory, miniature hard drive, memory card, optical storage, magnetic cassettes, magnetic tape, magnetic disk storage or other magnetic storage devices, or any other medium). The computer-readable memory 404 may also be described as computer storage media and may include volatile and nonvolatile, removable and non-removable media implemented in any method or technology for storage of information, such as computer readable instructions, data structures, program modules, or other data. Computer-readable memory 404, removable storage 406 and non-removable storage 408 are all examples of non-transitory computer-readable storage media. Computer-readable storage media include, but are not limited to, RAM, ROM, EEPROM, flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the computing device 400. Any such computer-readable storage media may be part of the computing device 400.

The memory 404 can include logic 418 (i.e., computer-executable instructions that, when executed, by the processor(s) 402, perform the various acts and/or processes disclosed herein) to implement automated dependency graph builder management, according to various examples as discussed herein. For example, the logic 418 is configured to carry out location-based computer-altered reality data rendering management using object characteristic data, via any of the user device(s) 102, and/or any of the server(s) 118-140. The memory 404 can further be used to store data 420, which may be used to implement location-based computer-altered reality data rendering management, as discussed herein. In one example, the data 420 may include any type of data (e.g., the computer-altered reality data (e.g., the XR data), the characteristic data, etc.), any type of information (e.g., the rendering location information, the network category information, etc.), and so on, or any combination thereof.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

What is claimed is:

1. A method comprising:
identifying initial computer-altered reality data, the initial computer-altered reality data including at least one of computer generated data or environment data, the environment data being received from a user device;
receiving characteristics data including at least one of user selection data or activity data;
identifying priority information associated with the characteristics data;
identifying rendering location information based on the priority information;
causing rendering of the initial computer-altered reality data to generate rendered computer-altered reality data based on the rendering location information; and
transmitting the rendered computer-altered reality data to the user device.

2. The method of claim 1, wherein:
the initial computer-altered reality data includes initial extended reality (XR) data, and the rendered computer-altered reality data includes rendered XR data, and
causing the rendering of the initial computer-altered reality data further comprises causing rendering of the initial XR data to generate the rendered XR data based on the rendering location information.

3. The method of claim 1, wherein identifying the rendering location information further comprises:
identifying network category information, the network category information including at least one of an edge category identifier, a near-edge category identifier, a mid-edge category identifier, or a far-edge category identifier; and
identifying, as an identified network category identifier in the rendering location information, the edge category identifier, the near-edge category identifier, the mid-edge category identifier, or the far-edge category identifier.

4. The method of claim 1, wherein causing the rendering of the initial computer-altered reality data further comprises:
causing at least one server associated with a network category to render, as the rendered computer-altered reality data, the initial computer-altered reality data based on network category information in the rendering location information.

5. The method of claim 1, wherein identifying the priority information further comprises:
identifying characteristics data metrics information including on at least one characteristics data metric associated with a computer-altered reality item, the characteristics data being analyzed to identify at least one of an interaction metric or a motion metric; and
identifying the priority information based on the characteristics data metrics information.

6. The method of claim 1, further comprising:
transmitting, to at least one server associated with a network location, the initial computer-altered reality data, the network location being indicated, by a network location identifier in the rendering location information, as an edge, a near-edge, a mid-edge, or a far-edge.

7. A system comprising:
at least one processor; and
non-transitory memory storing instructions that, when executed by the at least one processor, cause the at least one processor to perform operations comprising:
identifying computer-altered reality data associated with a user profile of a user associated with a user device;
receiving characteristics data associated with the computer-altered reality data;
identifying rendering location information based on the characteristics data;
causing generation of rendered computer-altered reality data based on the rendering location information; and
transmitting the rendered computer-altered reality data to the user device.

8. The system of claim 7, wherein causing the generation of rendered computer-altered reality data further comprises:
causing rendering, by at least one server in a network location, of the computer-altered reality data as the rendered computer-altered reality data, the network location being indicated via a network location identifier in the rendering location information, based on at least one metric associated the characteristics data, the at least one metric including at least one of an interaction metric or a motion metric.

9. The system of claim 7, wherein causing the generation of rendered computer-altered reality data further comprises:
causing rendering of the computer-altered reality data at a network location based on an interaction metric, the interaction metric corresponding to a level of interaction associated with a computer-altered reality data item, the computer-altered reality data item being indicated by a computer-altered reality data item identifier in the characteristics data.

10. The system of claim 7, wherein causing the generation of rendered computer-altered reality data further comprises:
causing rendering of the computer-altered reality data at a network location based on a motion metric, the motion metric corresponding to a level of motion associated a computer-altered reality data item, the computer-altered reality data item being indicated by a computer-altered reality data item identifier in the characteristics data.

11. The system of claim 7, wherein causing the generation of rendered computer-altered reality data further comprises:
causing rendering, at a first network location, and based on a first interaction metric and a first motion metric, of a first portion of computer-altered reality data, the first network location being associated with a first distance from the user device; and
causing rendering, at a second network location and based on a second interaction metric and a second motion metric, of a second portion of the computer-altered reality data, the second network location being associated with a second distance from the user device, the second distance being greater than or equal to the first distance, at least one of the second interaction metric and or the second motion metric being less than at least one of the first interaction metric and or the first motion metric, respectively.

12. The system of claim 7, wherein the computer-altered reality data includes extended reality (XR) data, and the rendered computer-altered reality data includes rendered XR data,
wherein causing the generation of the rendered computer-altered reality data further comprises:
causing, based on a first portion of the XR data, at least one first server associated with a network edge location to generate a first rendered portion of the rendered XR data;
causing, based on a second portion of the XR data, at least one second server associated with a network near-edge location to generate a second rendered portion of the rendered XR data;
causing, based on a third portion of the XR data, at least one third server associated with a network mid-edge location to generate a third rendered portion of the rendered XR data; and
causing, based on a fourth portion of the XR data, at least one fourth server associated with a network far-edge location to generate a fourth rendered portion of the rendered XR data.

13. The system of claim 7, wherein:
the computer-altered reality data includes extended reality (XR) data, and the rendered computer-altered reality data includes rendered XR data, and
causing the generation of the rendered computer-altered reality data further comprises causing generation of the rendered XR data based on the rendering location information, the rendering location information comprising a network location identifier associated with an edge location, a near-edge location, a mid-edge location, or a far-edge location of a network to which the user device is communicatively coupled.

14. The system of claim 7, wherein:
the computer-altered reality data includes extended reality (XR) data, and the rendered computer-altered reality data includes rendered XR data, and
causing the generation of the rendered computer-altered reality data further comprises:
causing, based on a first portion of the XR data having a first priority, at least one first server associated with a network edge location or a service provider network cloud location to generate a first rendered portion of the rendered XR data; and
causing, based on a second portion of the XR data having a second priority that is less than the first priority, at least one second server associated with a decentralized overlay network location or a public cloud overlay network location to generate a second rendered portion of the rendered XR data.

15. The system of claim 7, wherein causing the generation of the rendered computer-altered reality data further comprises:
causing, based on a first item of the computer-altered reality data having a first priority, at least one first server associated with service provider network to generate a first rendered portion of the rendered computer-altered reality data; and
causing, based on a second item of the computer-altered reality data having a second priority that is less than the first priority, at least one second server associated with a public network to generate a second rendered portion of the rendered computer-altered reality data.

16. A server, comprising:
at least one processor; and
non-transitory memory storing instructions that, when executed by the at least one processor, cause the at least one processor to perform operations comprising:
identifying computer-altered reality data associated with a user profile of a user associated with a user device;
identifying rendering location information based on location data associated with the user device;
causing rendering, as rendered computer-altered reality data, of the computer-altered reality data based on the rendering location information; and
transmitting the rendered computer-altered reality data to the user device.

17. The server of claim 16, wherein causing rendering of the computer-altered reality data further comprises:
causing rendering, at a first network location associated with a first distance from the user device, of a first item of the computer-altered reality data; and
causing rendering, at a second network location associated with a second distance from the user device, of a second item of the computer-altered reality data, the second distance being greater than or equal to the first distance based on a first priority associated with the first item greater than a second priority associated with the second item.

18. The server of claim 16, wherein causing the generation of the rendered computer-altered reality data further comprises:
causing rendering of a first subset of data of the computer-altered reality data at a first network location based on a first priority associated with the first subset of data, the first priority being identified based on a first interaction metric and a first motion metric, the first network location being associated with a first distance from the user device; and
causing rendering of a second subset of data of the computer-altered reality data at a second network location based on a second priority associated with the second subset of data, the second priority being identified based on a second interaction metric and a second motion metric, the second network location being associated with a second distance from the user device, the second distance being greater than or equal to the first distance, the second priority being less than the first priority.

19. The server of claim 16, wherein:
the computer-altered reality data includes extended reality (XR) data, and the rendered computer-altered reality data includes rendered XR data, and
causing the rendering of the computer-altered reality data further comprises causing generation of the rendered XR data based on the rendering location information, the rendering location information comprising a network location identifier associated with an edge location, a near-edge location, a mid-edge location, or a far-edge location of a network to which the user device is communicatively coupled.

20. The server of claim 16, wherein:
the computer-altered reality data includes extended reality (XR) data, and the rendered computer-altered reality data includes rendered XR data, and
causing the rendering of the computer-altered reality data further comprises:
causing, based on a first portion of the XR data having a first priority, at least one first server associated with a network near-edge location to generate a first rendered portion of the rendered XR data; and
causing, based on a second portion of the XR data having a second priority that is less than the first priority, at least one second server associated with a network far-edge location to generate a second rendered portion of the rendered XR data.
